(19) United States
(12) Patent Application Publication
(10) Pub. No.: US 2026/0103198 A1
(43) Pub. Date: Apr. 16, 2026

(54) LANE BEHAVIOR-BASED NAVIGATION FOR AUTONOMOUS OR SEMI-AUTONOMOUS SYSTEMS AND APPLICATIONS

(71) Applicant: NVIDIA Corporation, Santa Clara, CA (US)

(72) Inventors: Alireza Nemati, Newcastle, WA (US); Gulnara Ghorbanian, San Jose, CA (US); Amir Akbarzadeh, Alamo, CA (US); Heyu Liu, Newark, CA (US)

(21) Appl. No.: 18/916,348

(22) Filed: Oct. 15, 2024

(51) Int. Cl. B60W 30/18; G06V 10/44; G06V 10/70; G06V 20/58

(52) U.S. Cl. CPC B60W 30/18163; G06V 10/44; G06V 10/70; G06V 20/582; B60W 2420/403; B60W 2552/53; B60W 2555/60; B60W 2556/40

(57) ABSTRACT

In various examples, behaviors of road surface lanes may be determined and used to perform various functions associated with an autonomous or semi-autonomous machine, such as localization, path planning, etc. For instance, visual characteristics, patterns, and/or other attributes of lane line markings may be used to determine lane behavior with respect to at least a portion of a road network. At a highway interchange, for example, the lane line markings may be used to determine which lanes correspond to through traffic lanes, exit lanes, entrance lanes, auxiliary lanes, special use lanes (e.g., HOV lanes, emergency lanes, etc.), and/or any other types of lanes. In some examples, the disclosed systems and methods may use the determined lane behaviors to localize the machine with respect to the lanes of the driving surface, and/or to validate whether the machine is using the correct lane to follow a predefined route.

### BACKGROUND

For an autonomous or semi-autonomous machine to safely navigate through an environment, the vehicle may rely on maps—such as navigational, standard definition (SD), and/or high-definition (HD) maps—corresponding to an environment in which the machine intends to operate. Due to the detailed, three-dimensional, high precision nature of HD maps, navigating according to HD maps has proven effective for safe navigation of environments where HD map information is available. For example, a machine may use an HD map to perform one or more tasks, such as localizing the machine within an environment and/or determining trajectories to navigate within the environment.

However, generating HD maps, as well as providing (e.g., streaming) contemporary HD maps to machines, may be computationally and/or resource intensive. As such, HD maps may be unavailable for certain portions of an environment. In such scenarios, autonomous or semi-autonomous machines may be required to use navigation, SD maps and/or other techniques to navigate those portions of the environment, even though these sources of data used may be less reliable than HD maps. For instance, in contrast to HD maps, navigational or SD maps may lack finer details, thereby making it challenging for machines to perform navigation-related functions with too much reliance on the map data, especially at complex portions of a road network.

### SUMMARY

Embodiments of the present disclosure relate to lane behavior-based navigation for autonomous or semi-autonomous systems and applications. For instance, systems and methods described herein may be used to determine behaviors of lanes of a road surface and use the behaviors to perform various functions associated with an autonomous or semi-autonomous machine, which may include, but are not limited to, localization, path planning, lane changes, control, navigation, etc. In some instances, visual characteristics, patterns, and/or other attributes of surface markings, traffic signs, or other perceived features in an environment may be used to determine lane behavior with respect to at least a portion of a road network. At a highway interchange, for example, lane line markings and/or traffic signs may be used to determine which lanes correspond to through traffic lanes, exit lanes, entrance lanes, auxiliary lanes, special use lanes (e.g., HOV lanes, emergency lanes, etc.), and/or any other types of lanes. In some examples, the disclosed systems and methods may use the determined lane behaviors to localize the machine with respect to the lanes of the driving surface, and/or to validate whether the machine is using the correct lane to follow a predefined route. In some instances, the systems and methods may determine or update a lane-level path for the machine to follow based on the lane behaviors, and the path may correspond to an intended or predefined route of the machine.

In contrast to conventional systems, the systems of the present disclosure, in some embodiments, are able to determine lane behaviors and/or functions at various portions of a road network—including complex junctions and interchanges. Additionally, the systems of the present disclosure, in some embodiments, then provide techniques for determining whether autonomous or semi-autonomous machines are using the correct lanes to navigate a defined route. As such, and as described in more detail herein, by performing such processes, the systems of the present disclosure may allow autonomous or semi-autonomous machines to safely navigate through an environment without having to rely upon an HD map of the environment. This provides improvements over the conventional systems that may require machines use HD map data to navigate an environment, which may be computationally and/or resource-intensive. Additionally, by using surface markings and/or other perceived features to determine lane behavior, the systems of the present disclosure may allow autonomous or semi-autonomous machines to more accurately obtain additional insight relating to roadway environments ahead of the machines, which may enable safer autonomous or semi-autonomous navigation by understanding traffic rules and expected behavior of other machines operating in the environment.

### BRIEF DESCRIPTION OF THE DRAWINGS

The present systems and methods for lane behavior-based navigation for autonomous or semi-autonomous systems and applications are described in detail below with reference to the attached drawing figures, wherein:

FIG. 1 illustrates an example data flow diagram for a process of determining and using lane behaviors for autonomous or semi-autonomous navigation, in accordance with some embodiments of the present disclosure;

FIG. 2 illustrates an example visualization of perception data, in accordance with some embodiments of the present disclosure;

FIGS. 3A-3F illustrate examples of lane behaviors that may be determined using various lane line markings, in accordance with some embodiments of the present disclosure;

FIG. 4 illustrates an example of a navigation, SD map, in accordance with some embodiments of the present disclosure;

FIG. 5 illustrates an example of using lane behavior to plan a path for a machine to follow that corresponds to a route of the machine, in accordance with some embodiments of the present disclosure;

FIG. 6 is a data flow diagram illustrating an example of a process for training one or more machine learning models to perform one or more aspects associated with one or more of the processes described herein, in accordance with some embodiments of the present disclosure;

FIG. 7 illustrates an example of a system that may perform one or more of the processes described herein, in accordance with some embodiments of the present disclosure;

FIG. 8 is a flow diagram illustrating an example of a method for using lane behaviors to determine whether a machine is using a correct lane to navigate a route, in accordance with some embodiments of the present disclosure;

FIG. 9 is a flow diagram illustrating an example of a method for selecting a path for a machine based at least on a behavior of the path, in accordance with some embodiments of the present disclosure;

FIG. 10A is an illustration of an example autonomous vehicle, in accordance with some embodiments of the present disclosure;

FIG. 10B is an example of camera locations and fields of view for the example autonomous vehicle of FIG. 10A, in accordance with some embodiments of the present disclosure;

FIG. 10C is a block diagram of an example system architecture for the example autonomous vehicle of FIG. 10A, in accordance with some embodiments of the present disclosure;

FIG. 10D is a system diagram for communication between cloud-based server(s) and the example autonomous vehicle of FIG. 10A, in accordance with some embodiments of the present disclosure;

FIG. 11 is a block diagram of an example computing device suitable for use in implementing some embodiments of the present disclosure; and

FIG. 12 is a block diagram of an example data center suitable for use in implementing some embodiments of the present disclosure.

### DETAILED DESCRIPTION

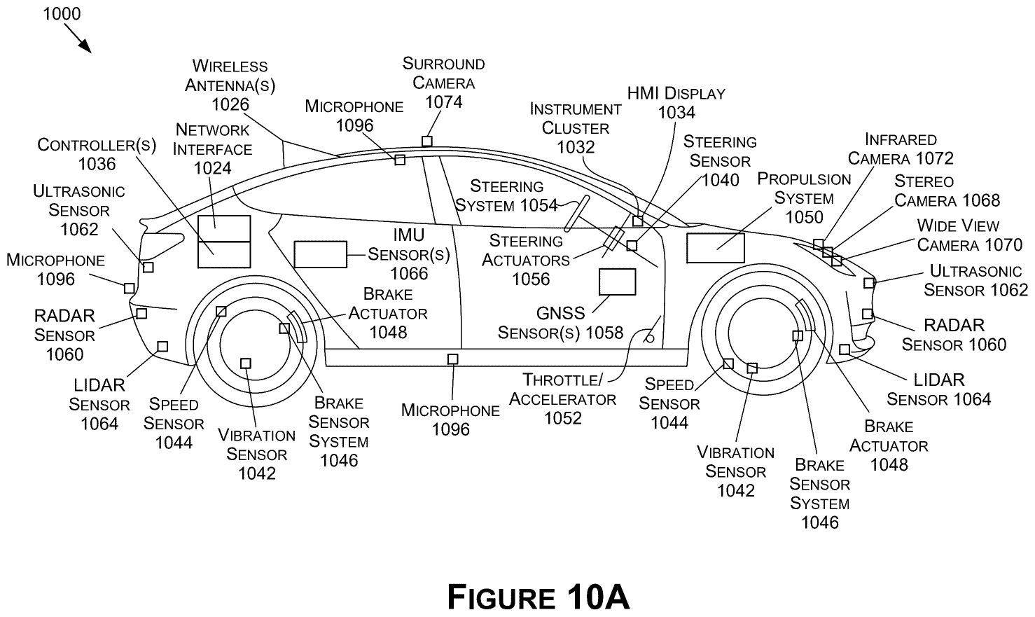

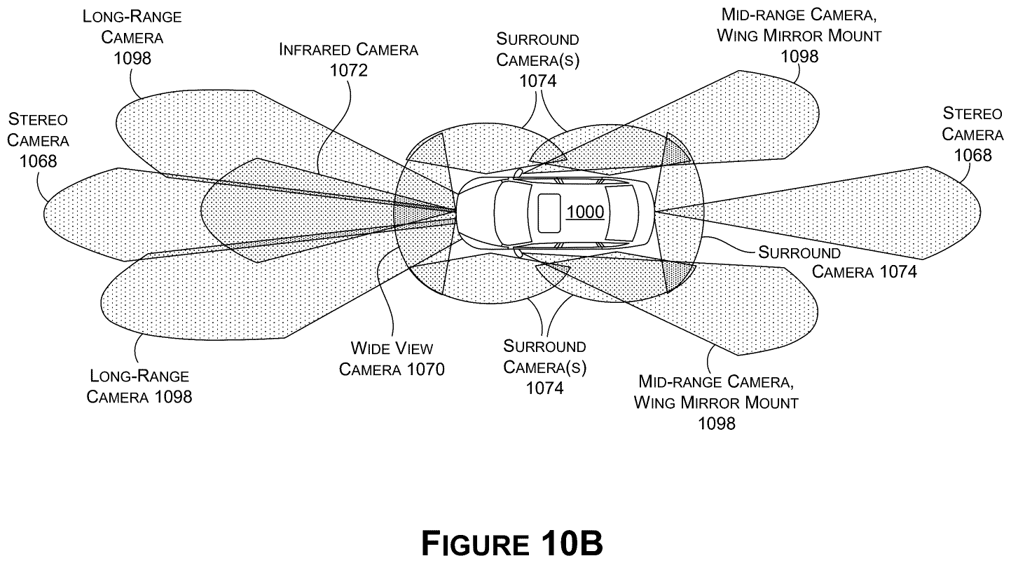

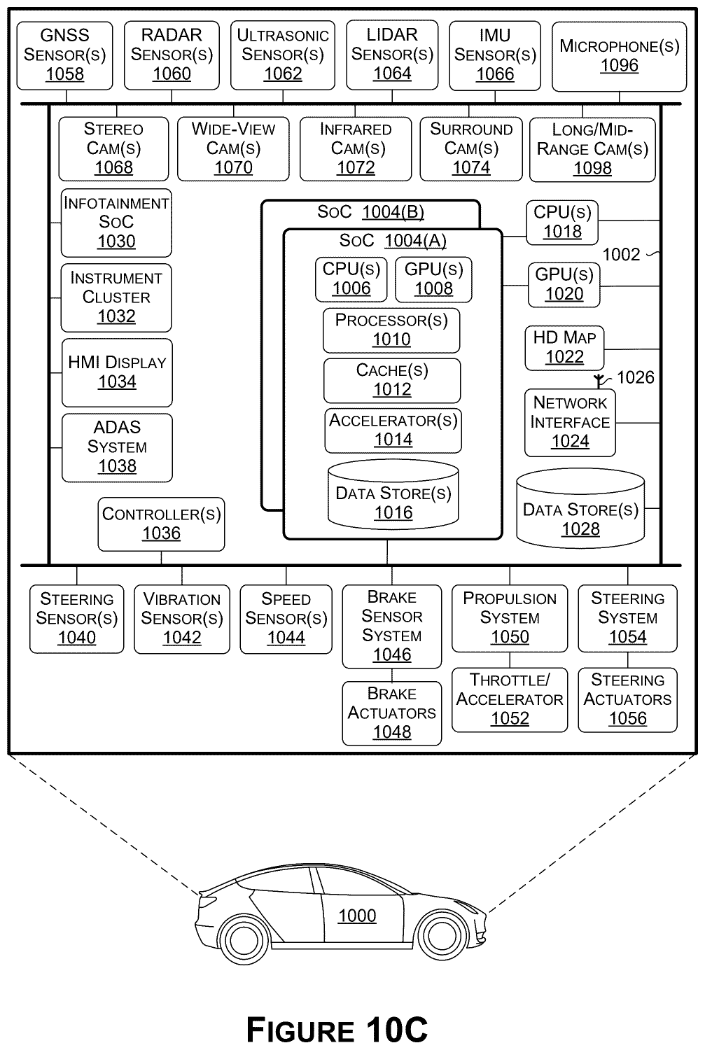

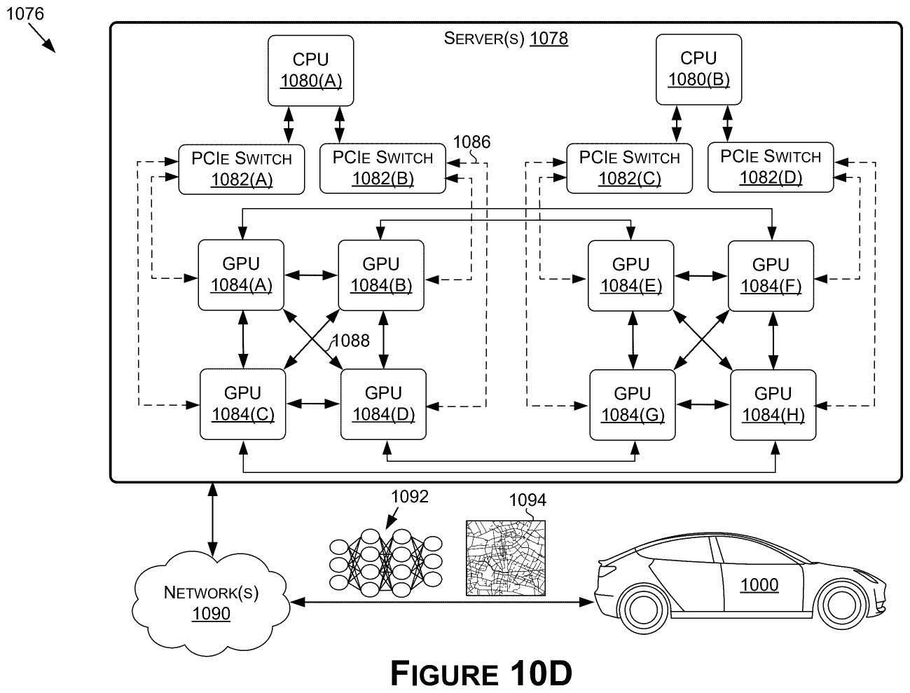

Systems and methods are disclosed related to lane behavior-based navigation for autonomous or semi-autonomous systems and applications. Although the present disclosure may be described with respect to an example autonomous or semi-autonomous vehicle or machine 1000 (alternatively referred to herein as “vehicle 1000,” “ego-vehicle 1000,” “ego-machine 1000,” or “machine 1000,” an example of which is described with respect to FIGS. 10A-10D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to vehicle localization relative to lanes of a driving surface, this is not intended to be limiting, and the systems and methods described herein may be used in augmented reality, virtual reality, mixed reality, robotics, security and surveillance, autonomous or semi-autonomous machine applications, and/or any other technology spaces where maps, perception, planning, and localization may be used.

For instance, a system(s) may receive perception data generated using one or more perception systems of a machine (e.g., an autonomous or semi-autonomous machine or vehicle) navigating within an environment. In some examples, the perception system(s) may process and/or analyze one or more modalities of sensor data to generate the perception data. The sensor data may be captured or otherwise generated using one or more sensors of the machine. As described herein, the sensor data may include, but is not limited to, LiDAR data generated using one or more LiDAR sensors, image data generated using one or more image sensors (e.g., one or more cameras), RADAR data generated using one or more RADAR sensors, ultrasonic data generated using one or more ultrasonic sensors, and/or any other type of sensor data generated using any other type of sensor. In some examples, the perception data may indicate, among other things, various features associated with the environment. For instance, the perception data may indicate locations of various objects in the environment. In some examples, the objects may include, but are not limited to, machines (e.g., vehicles), pedestrians, animals, buildings, trees and vegetation, traffic signs, traffic lights, or any other objects.

As described herein, in some examples, the perception data may also indicate or represent various features associated with lanes of a driving surface and/or other paths in the environment. For instance, the perception data may indicate information associated with lane line markings corresponding to the lanes, other surface markings corresponding to the lanes (e.g., arrow marks, etc.), geometries of the lanes, or any other information. The information associated with the lane line markings may include locations of the lane line markings, classifications associated with the lane line markings (e.g., line type, line color, etc.), patterns associated with the lane line markings, or any other details. In some examples, the perception data may include an image of the environment that is labeled or annotated to indicate the various information associated with the objects or features of the environment. For instance, lane line markings represented in the perception data may be annotated to indicate locations of the lane lines, types of the lane lines (e.g., dashed lines, solid lines, etc.), colors of the lane lines (e.g., white, yellow, etc.) or any other information.

In some examples, the system(s) may analyze the perception data to determine behaviors associated with the lanes in the perception data. For instance, the system(s) may analyze the perception data to classify or otherwise determine line types associated with the lane line markings, patterns associated with the lane line markings, or any other attributes associated with the lane line markings. Using this information, the system(s) may determine traffic rules that correspond to those types and/or patterns of lane lines. For instance, according to traffic rules for certain geographic areas, a dashed lane line separating two lanes may indicate that vehicles are allowed to cross the dashed lane line and move back and forth between the two lanes freely, or as traffic permits. On the other hand, a solid lane line separating two lanes may indicate that vehicles are not allowed to cross the solid lane line to move back and forth between the two lanes—or at least the vehicles are to be discouraged from doing so. In some examples, the system(s) may determine a location or geographic region that a machine is operating in to determine the traffic rules that correspond to different types of lane lines. For instance, lane line types used in North America may represent different traffic rules than lane line types used in Asia or Europe. The system(s) may use a machine learning model or a rulebook to determine traffic rules for different types of lanes in different geographic areas.

In some examples, the system(s) may use the traffic rules associated with the lane line types to determine the behaviors of the lanes. In some instances, the behaviors associated with the lanes may be indicative of roles or functions of the lanes with respect to the overall road network and/or specific portions of the road network. In other words, the behavior of a lane may indicate how the lane interacts, or a specific use of the lane, with respect to at least a portion of the road network and/or one or more other lanes. As an example, for lanes associated with a highway interchange, behaviors associated with the lanes may indicate whether the lanes correspond to through traffic lanes, exit lanes, entrance lanes, auxiliary lanes, special use lanes (e.g., HOV lanes, emergency lanes, etc.), and/or any other types of lanes. As another example, for lanes associated with an intersection (e.g., a 4-way intersection, a light-controlled intersection, etc.), the behaviors associated with the lanes may indicate whether the lanes correspond to through traffic lanes, dedicated turn lanes, dual-purpose lanes (e.g., through-and-turn-lanes), or other types of lanes.

In some examples, the system(s) may keep track of line types associated with the lane lines and use the tracked line types to assist in determining the behaviors of the lanes. That is, as the system(s) classifies lane line types as the machine moves through the environment, the system(s) may keep track of the types of lanes lines to determine changes in the lane line types, which may indicate changes in behaviors of the lanes. For instance, if a left lane line of a lane changes from dashed to solid, this may indicate the lane behavior is changing to an exit lane. Additionally, or alternatively, if a right lane line of a lane changes from solid, to dashed, to no lane line at all, this may indicate that two lanes are merging into one lane, and that one of the two lanes is ending.

In some examples, the system(s) of the present disclosure may use the determined lane behaviors to determine how the lanes relate to the topology of the road network, such as which lanes lead to which road segments of the road network. For instance, the system(s) may compare the lane line markings and/or lane behaviors with map data representing a map of the road network topology, and determine which lanes lead to which road segments. As an example, consider a road network topology ahead of a machine that includes a main road segment (e.g., the road segment the machine is currently on) that continues straight, a first road segment that deviates left of the main road segment, and a second road segment that deviates right of the main road segment. If the main road segment (prior to the junction(s)) includes three lanes, and the system(s) determines that the behavior of the left lane is an exit lane, the behavior of the middle lane is a through traffic lane, and the behavior of the right lane is an exit lane, then the system(s) may use the road topology to determine or predict that the left lane leads to the first road segment, the middle lane continues on the main road segment, and the right lane leads to the second road segment.

By determining how the lanes relate to the topology of the road network, the system(s) may improve localization of the machine. For instance, the system(s) may use the lane behaviors, map data, sensor data, and/or other data to generate localization data indicating a location of the machine with respect to the lanes of the road network. In some examples, the localization data may indicate the lane the machine is currently using, as well as which road segment that lane leads to if the machine continues to stay in that lane. In other words, by determining the lane behaviors and relating the lane behaviors to the road network topology as a whole and/or other road network events (e.g., junctions, intersections, interchanges, highway exits, highway entrances, etc.) ahead of the machine, the system(s) of the present disclosure may generate localization data that includes lane-level detail without relying on an HD map to obtain the lane-level detail.

In some examples, the system(s) may use the determined lane behaviors, the localization data, and/or other data to determine or refine a path (e.g., a lane-level path) for the machine to follow through the environment. For example, the machine may be traversing the environment according to a predefined route between a starting point and a destination. The route may be a road-level route based on a navigation, SD map of the environment. As such, the route may indicate which road segments the machine should use, estimated locations where the machine should turn from one road segment onto another road segment, etc. However, as the navigation SD map may not include lane-level information, the route the machine is following may not specify which lanes the machine should use to navigate the route. As such, the machine may, at times, be using an incorrect lane for the route (e.g., using a through traffic lane when needing to use a turning lane). However, the system(s) of the present disclosure may use the lane behaviors, the localization data, and/or other data to refine the path for the machine to follow and/or provide the machine with a lane-level path that includes greater detail than the road-level route the machine is following.

In some examples, to determine or refine the path for the machine, the system(s) may obtain the route of the machine indicating the road segments to use to navigate from a first location to a second location. The system(s) may use the lane behaviors to determine which lanes should be used for which road segments. That is, the system(s) may determine which lanes lead to which road segments based on the predicted lane behaviors and the topology of the road network indicated in the navigation, SD map. Based on determining which lane(s) should be used for the road segments of the route, the system(s) may determine whether the machine is using that/those lane(s). For instance, the system(s) may use the localization data to determine which lane the machine is using. The system(s) may plan the path of the machine based on the machine's current location. For instance, if the machine is using an incorrect or non-optimal lane, the system(s) may plan a path for the machine to cause the machine to change lanes or otherwise alter the machine's current/previous path. Additionally, or alternatively, if the machine is already using the correct/optimal lane, the system(s) may plan a path that ensures the machine continues to use the optimal lane and subsequent optimal lanes.

In some embodiments, the systems and methods described herein may be performed within a simulation environment (e.g., NVIDIA's DriveSIM) using simulated data (e.g., simulated sensor data of simulated sensors of a virtual or simulated machine). For example, simulated input data (e.g., map data, perception data, or any other data described herein) may be used to determine lane behavior, optimal lanes for navigational routes, etc., and this information may be used to perform operations associated with the virtual machine within the simulation environment. These simulated operations may be used to test performance of the underlying algorithms, systems, and/or processes prior to deploying them in the real-world. In some instances, the simulation may be used to generate synthetic training data—e.g., perception data indicative of lane line markings and/or other surface markings, as well as traffic signs, road signs, informational signs, etc. from within the simulation. The synthetic training data (in addition to or alternatively from real-world data) may then be processed to determine path or lane behavior and localize a machine with respect to a higher-level (e.g., less detailed) map associated with the environment, such as determining behaviors of different paths in a warehouse to determine which paths lead to which areas of the warehouse, for example.

In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications. In some examples, the simulation environment may include a digital twin of a real environment, such as a digital twin of a specific stretch of roadway, a warehouse, a data center, an airport, a geographic area, a marine area, or any other real environment where autonomous or semi-autonomous machines may operate.

In some embodiments, teleoperation or remote control of a vehicle or other machine may be performed using a remote control or teleoperation system. For example, the systems and methods described herein may be used to identify lane lines, road boundary lines, longitudinal features, lane behaviors, etc. that may be included in a visualization or mapping of an environment to aid a remote operator in controlling—or providing waypoints or other indications of control or navigation—an autonomous or semi-autonomous machine through an environment.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models, such as large language models (LLMs), vision language models (VLMs), and/or multi-modal language models, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

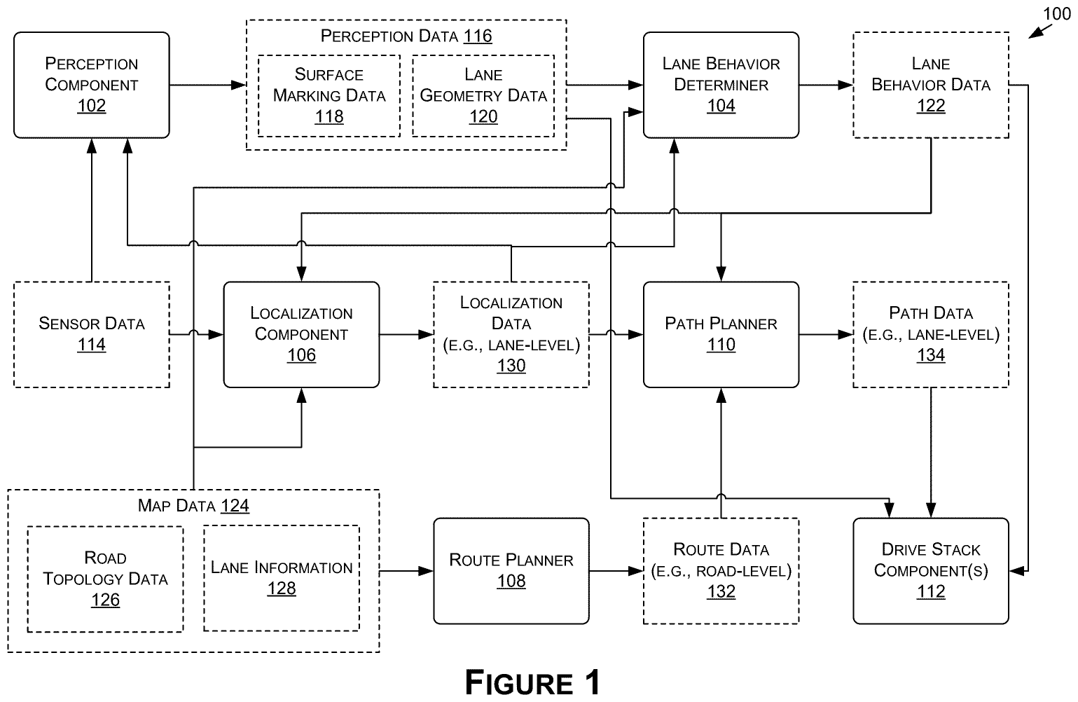

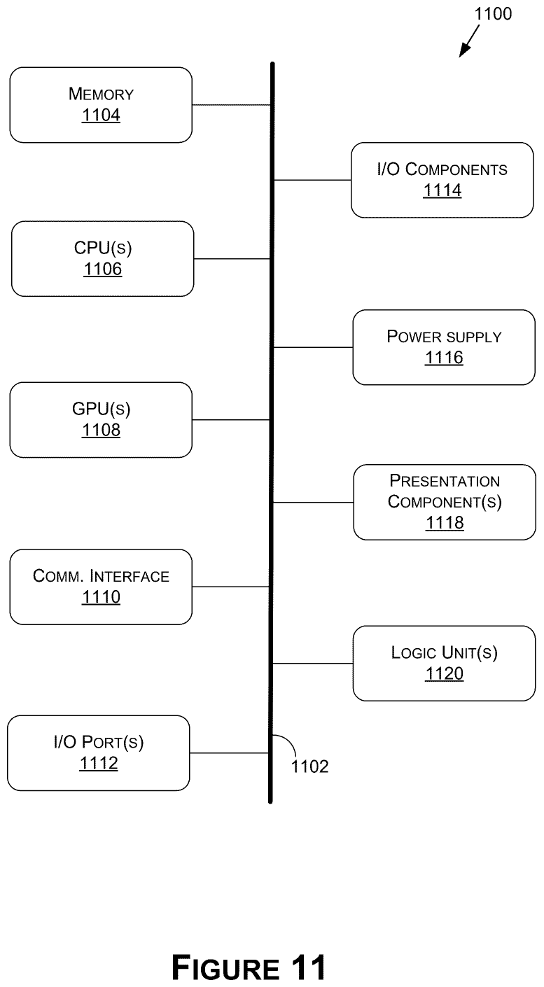

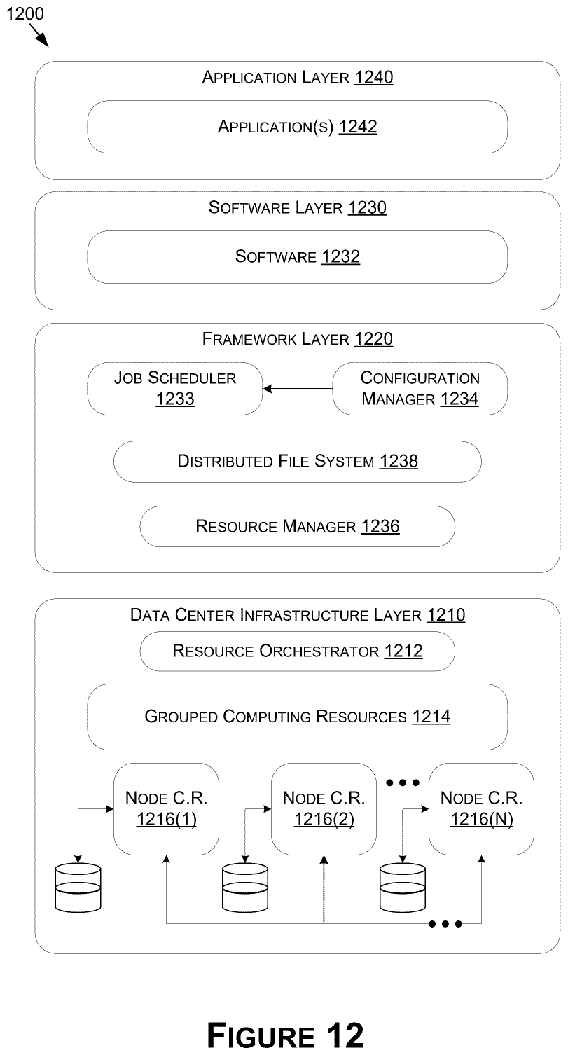

With reference to FIG. 1, FIG. 1 illustrates an example data flow diagram for a process 100 of determining and using lane behaviors for autonomous or semi-autonomous navigation, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1000 of FIGS. 10A-10D, example computing device 1100 of FIG. 11, and/or example data center 1200 of FIG. 12.

The process 100 may be implemented using, amongst additional or alternative components, a perception component 102, a lane behavior determiner 104, a localization component 106, a route planner 108, a path planner 110, and one or more drive stack components 112. In some examples, the components described with respect to the process 100 may correspond to one or more components of a machine, such as the autonomous vehicle 1000 described herein.

As an overview of the process 100, the perception component 102 may use sensor data 114 and/or localization data 130 to generate perception data 116, which may include surface marking data 118 representative of at least lane line markings, as well as lane geometry data 120 indicating geometries of lanes of a driving surface. The lane behavior determiner 104 may use the perception data 116, the map data 124, and/or the localization data 130 to determine behaviors of the lanes of the driving surface, which may be represented using the lane behavior data 122. The localization component 106 may use the sensor data 114, the lane behavior data 122, and/or map data 124—which may include road topology data 126 and lane information 128, in some instances—to generate localization data 130 indicating a lane-level location of the machine. The route planner 108 may use the map data 124 to determine (e.g., map out, define, etc.) a route for the machine to follow, which may be represented using the route data 132. The path planner 110 may use the lane behavior data 122, the localization data 130, and/or the route data 132 to determine a path (e.g., a more refined or higher-detailed version of the route) for the machine to follow, which may be represented using the path data 134. One or more of the drive stack component(s) 112 may use the path data 134, the perception data 116, and/or the lane behavior data 122 to perform one or more operations associated with the machine, or use the path data 134, the perception data 116, and/or the lane behavior data 122 as inputs to other algorithms, models, processes, etc. associated with the machine.

In some instances, the sensor data 114 may include one or more different modalities of sensor data. For instance, the sensor data 114 may include, but is not limited to, LiDAR data generated using one or more LiDAR sensors, image data generated using one or more image sensors (e.g., one or more cameras), RADAR data generated using one or more RADAR sensors, ultrasonic data generated using one or more ultrasonic sensors, and/or any other type of sensor data generated using any other type of sensor.

In some examples, the sensor data 114 may be captured in one format (e.g., RCCB, RCCC, RBGC, etc.), and then converted (e.g., during pre-processing of the sensor data) to another format. In some other examples, the sensor data 114 may be provided as input to a sensor data or image data pre-processor (not shown) to generate pre-processed image data. Many types of images or formats may be used as inputs; for example, compressed images such as in Joint Photographic Experts Group (JPEG), Red Green Blue (RGB), or Luminance/Chrominance (YUV) formats, compressed images as frames stemming from a compressed video format (e.g., H.264/Advanced Video Coding (AVC), H.265/High Efficiency Video Coding (HEVC), VP8, VP9, Alliance for Open Media Video 1 (AV1), Versatile Video Coding (VVC), or any other video compression standard), raw images such as originating from Red Clear Blue (RCCB), Red Clear (RCCC) or other type of imaging sensor. In some examples, different formats and/or resolutions could be used for training the perception component 102 and/or one or more models or algorithms of the perception component 102 than for inferencing (e.g., during deployment of the perception component 102 in the autonomous vehicle 1000).

A sensor data or image data pre-processor may use data representative of one or more images (or other data representations, such as LiDAR depth maps) and load the sensor data into memory in the form of a multi-dimensional array/matrix (alternatively referred to as tensor, or more specifically an input tensor, in some examples). The array size may be computed and/or represented as W×H×C, where W stands for the image width in pixels, H stands for the height in pixels, and C stands for the number of color channels. Without loss of generality, other types and orderings of input image components are also possible. In some embodiments, batching may be used for training and/or for inference. In such examples, the batch size B may be used as a dimension (e.g., an additional fourth dimension). Thus, the input tensor may represent an array of dimension W×H×C×B. Any ordering of the dimensions may be possible, which may depend on the particular hardware and software used to implement the sensor data or image data pre-processor. This ordering may be chosen to maximize training and/or inference performance of the perception component 102.

In some embodiments, a pre-processing image pipeline may be employed by the sensor data or image data pre-processor to process a raw image(s) acquired by a sensor(s) (e.g., camera(s)) and included in the sensor data 114 to produce pre-processed image data or sensor data which may represent an input image(s) to an input layer(s) (e.g., feature extraction layers) of one or more neural networks (e.g., deep neural networks (DNNs), convolutional neural networks (CNNs), etc.) of the perception component 102. An example of a suitable pre-processing image pipeline may use a raw RCCB Bayer (e.g., 1-channel) type of image from the sensor and convert that image to a RCB (e.g., 3-channel) planar image stored in Fixed Precision (e.g., 16-bit-per-channel) format. The pre-processing image pipeline may include decompanding, noise reduction, demosaicing, white balancing, histogram computing, and/or adaptive global tone mapping (e.g., in that order, or in an alternative order).

Where noise reduction is employed by the image data pre-processor, it may include bilateral denoising in the Bayer domain. Where demosaicing is employed by the image data pre-processor, it may include bilinear interpolation. Where histogram computing is employed by the sensor data or image data pre-processor, it may involve computing a histogram for the C channel, and may be merged with the decompanding or noise reduction in some examples. Where adaptive global tone mapping is employed by the sensor data or image data pre-processor, it may include performing an adaptive gamma-log transform. This may include calculating a histogram, getting a mid-tone level, and/or estimating a maximum luminance with the mid-tone level.

In various examples, the perception component 102 may include one or more machine learning models—such as one or more DNNs, one or more CNNs, one or more LLMs, one or more VLMs, one or more multimodal language models, and/or any other machine learning models—and/or one or more classical (e.g., non-learned) models—such as algorithmic sensor processing, probabilistic processing, thresholding, feature extraction, filtering, etc., which may be single-modality and/or fused. The various models of the perception component 102 may be configured to analyze the sensor data 114 and detect various objects (e.g., vehicles, pedestrians, animals, buildings, vegetation, etc.) and features (e.g., path features such as roadways, lanes, road surface markings, lane line markings, road signs, etc.) represented in the sensor data 114. The detected objects and/or features may be indicated in the perception data 116. For instance, the perception component 102—and/or a specific model(s) of the perception component 102—may be configured to detect lane line markings or other surface markings of a driving surface, among other things, and represent the detected surface markings in the perception data 116 (e.g., by annotating the edges of the lanes, centerlines or center “rails” of the lanes, etc.). For instance, the surface marking data 118 may indicate locations, classifications (e.g., lane line types), colors, etc. of surface markings. The perception data 116 may also indicate geometries of the lanes, which may be represented using the lane geometry data 120. A geometry of a lane may include, but is not limited to, one or more of a curvature of the lane, a width of the lane, a slope of the lane, a camber of the lane, and/or an incline of the lane.

Although examples are described herein with respect to the perception component 102 using neural networks, and specifically DNNs or CNNs in machine learning models, this is not intended to be limiting. For example, and without limitation, any of the various machine learning models described herein as being used by the perception component 102—or any other component(s)—may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, LLM, VLM, multi-modal language model, diffusion, transformer, encoder-only, decoder-only, encoder-decoder, etc.), and/or other types of machine learning models.

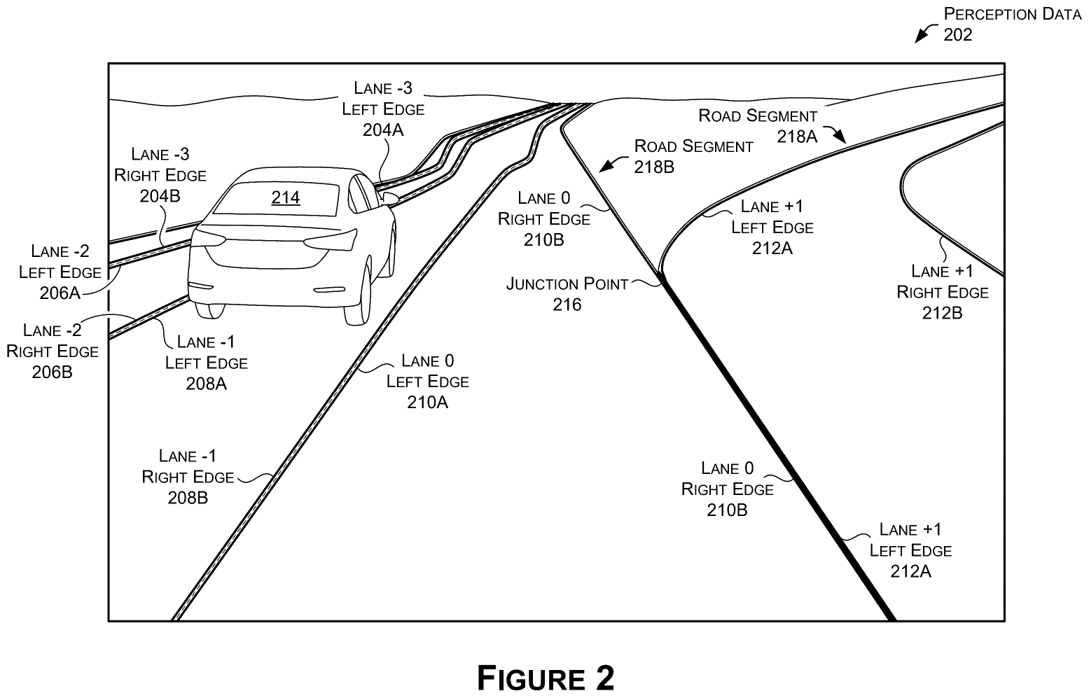

As described above and herein, the perception data 116 may indicate various features associated with lanes of a driving surface and/or other objects or features in the environment. For instance, FIG. 2 illustrates an example visualization of perception data 202, in accordance with some embodiments of the present disclosure. The perception data 202 may, in some examples, correspond to the perception data 116 of the example of FIG. 1. In the example of FIG. 2, the perception data 202 includes an image with five annotated lanes—an ego lane 210 (e.g., lane 0), a right of ego-lane 212 (e.g., lane +1), a first left of ego-lane 208 (e.g., lane −1), a second left of ego-lane 206 (e.g., lane −2), and a third left of ego-lane 204 (e.g., lane −3). The perception data 202 may include lane label(s) for edges of the lanes (which may correspond to lane line markings), such that left edge 204A and right edge 204B delineate the lane 204, left edge 206A and right edge 206B delineate the lane 206, left edge 208A and right edge 208B delineate the lane 208, left edge 210A and right edge 210B delineate the lane 210, and left edge 212A and right edge 212B delineate the lane 212. In some examples, the perception data 202 may also indicate the types of the lane line markings, such as whether the lane line marking for the left edge 210A and right edge 208B is a dashed line, a solid line, a double line, etc. The perception data 202 also includes a vehicle 214 that may be detected by the perception component 102.

In the example of FIG. 2, the frame of the perception data 202 also illustrates a junction associated with the lanes, where the right of ego-lane 212 (e.g., lane +1) deviates from the ego lane 210 (e.g., lane 0). For instance, a junction point 216 is labeled in the frame of perception data 202 illustrated in the example of FIG. 2. The junction point 216 may be a junction between lanes and/or road segments. For instance, subsequent to the junction point 216, a first road segment 218A deviates from a second road segment 218B, and the right of ego-lane 212 (e.g., lane +1) follows the first road segment 218A and deviates from the ego lane 210 (e.g., lane 0), which remains on the second road segment 218B.

Referring back to the example of FIG. 1, the process 100 may include the lane behavior determiner 104 using the perception data 116 to determine behaviors of lanes of the driving surface. For instance, the lane behavior determiner 104 may analyze the perception data 116 to classify or otherwise determine line types associated with the lane line markings, patterns associated with the lane line markings, or any other attributes associated with the lane line markings. Using this information, the lane behavior determiner 104 may determine traffic rules that correspond to those types and/or patterns of lane lines. For instance, according to traffic rules for certain geographic areas, a dashed lane line separating two lanes may indicate that vehicles are allowed to cross the dashed lane line and move back and forth between the two lanes freely, or as traffic permits. On the other hand, a solid lane line separating two lanes may indicate that vehicles are not allowed to cross the solid lane line to move back and forth between the two lanes—or at least the vehicles are to be discouraged from doing so. In some examples, the lane behavior determiner 104 may determine a location or geographic region that the machine is operating in to determine the traffic rules that correspond to different types of lane lines. For instance, lane line types used in North America may represent different traffic rules than lane line types used in Asia or Europe, so in order to determine what traffic rule(s) are conveyed by different types of lane lines, the lane behavior determiner 104 may need to determine the geographic region wherein the machine is operating.

In some examples, the lane behavior determiner 104 may use the traffic rules associated with the lane line types to determine the behaviors of the lanes, which may be represented using the lane behavior data 122. In some instances, the behaviors associated with the lanes may be indicative of roles or functions of the lanes with respect to the overall road network as a whole and/or specific portions of the road network. In other words, the behavior of a lane may indicate how the lane interacts, or a specific use of the lane, with respect to at least a portion of the road network. As an example, for lanes associated with a highway interchange, the lane behavior data 122 may indicate whether the lanes correspond to through traffic lanes, exit lanes, entrance lanes, auxiliary lanes, special use lanes (e.g., HOV lanes, emergency lanes, etc.), and/or any other types of lanes. As another example, for lanes associated with an intersection (e.g., a 4-way intersection, a light-controlled intersection, etc.), the lane behavior data 122 may indicate whether the lanes correspond to through traffic lanes, dedicated turn lanes, dual-purpose lanes (e.g., through-and-turn-lanes), or other types of lanes.

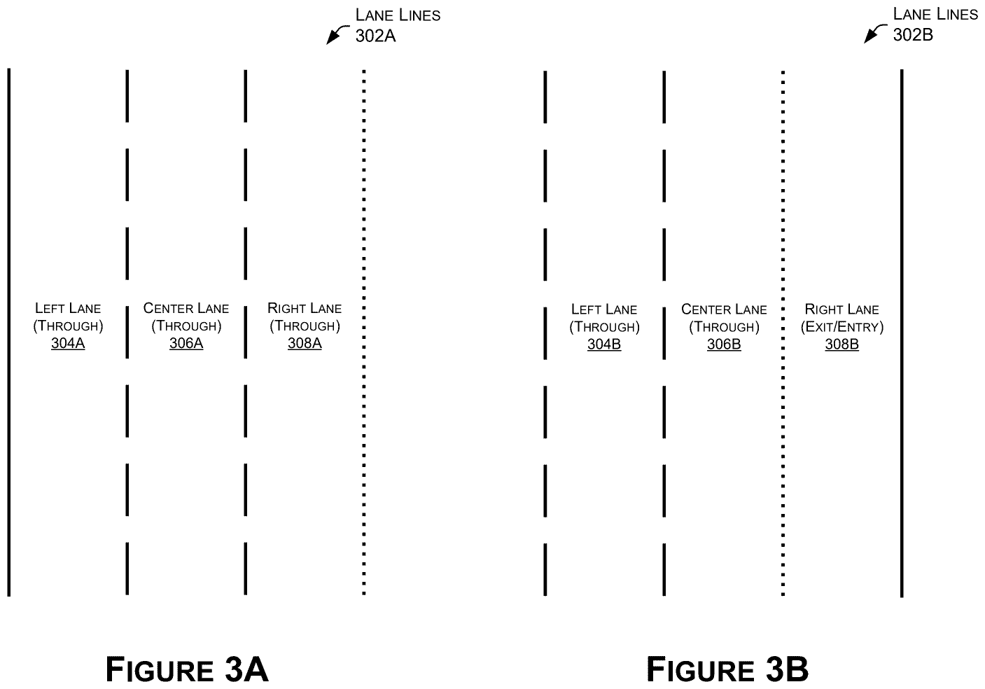

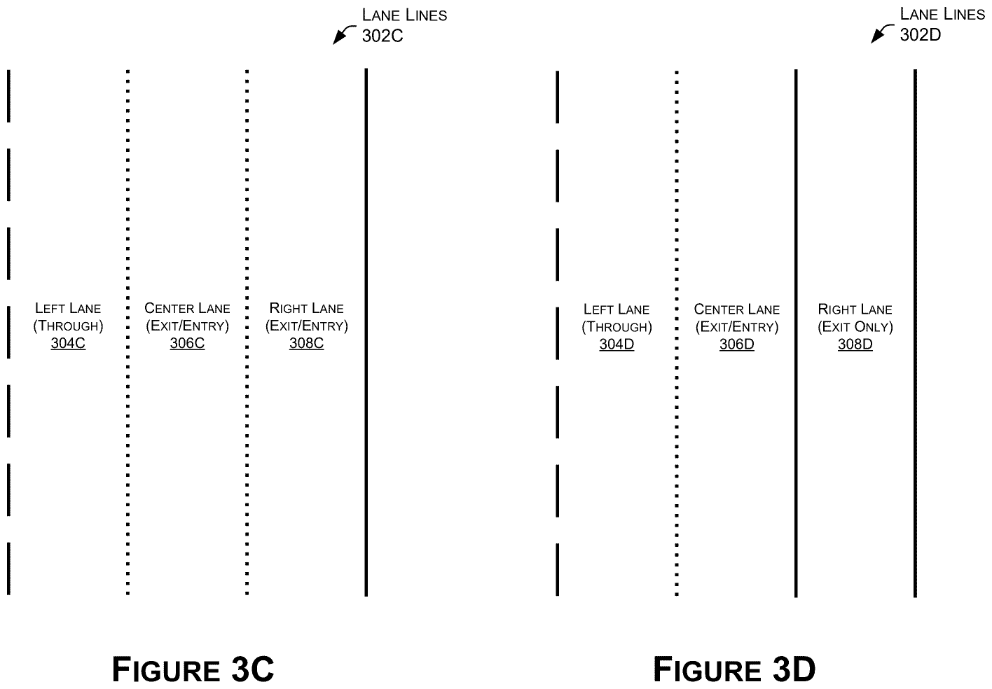

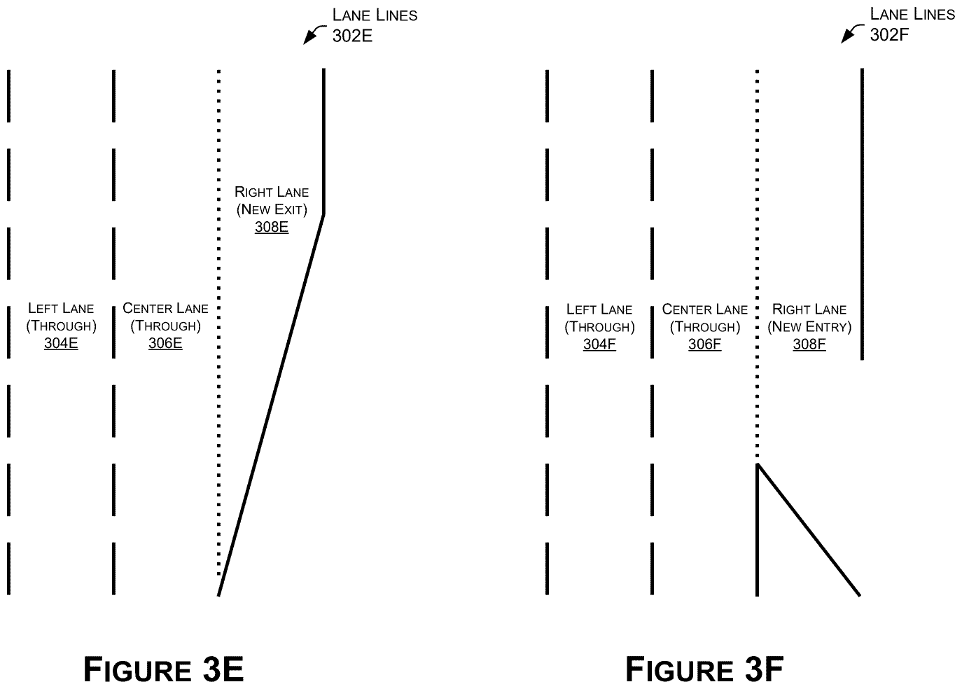

For instance, FIGS. 3A-3F illustrate example lane behaviors that may be determined using various lane line markings, in accordance with some embodiments of the present disclosure. Referring first to FIG. 3A, lane lines 302A associated with a left lane 304A, a center lane 306A, and a right lane 308A are illustrated. For instance, the left lane 304A may include a solid line for its left lane line and a dashed line for its right lane line, the center lane 306A may include dashed lines for both its left and right lane lines, and the right lane 308A may include a dashed line for its left lane line and a short-dashed line for its right lane line. In some examples (e.g., in some geographic regions), traffic rules associated with solid lines may discourage or not permit vehicles from crossing over solid lines, and traffic rules for dashed lane lines may permit vehicles to cross over (e.g., change lanes from the left lane 304A to the center lane 306A to the right lane 308A, and vice versa. Additionally, traffic rules for short-dashed lines may include that a lane is about to end or merge with another lane (e.g., also referred to as a “drop lane”). As such, the lane behavior determiner 104 may determine that the behaviors of the left lane 304A, the center lane 306A, and the right lane 308A are each through lanes or lanes that continue straight along a road segment. The lane behavior determiner 104 may also infer a presence of another lane to the right of the right lane 308A based on the short-dashed line.

Referring next to FIG. 3B, lane lines 302B associated with a left lane 304B, a center lane 306B, and a right lane 308B are illustrated. For instance, the left lane 304B may include a dashed line for its left lane line and a dashed line for its right lane line, the center lane 306B may include the dashed line for its left lane line and a short-dashed line for its right lane line, and the right lane 308B may include the short dashed line for its left lane line and a solid line for its right lane line. In some examples (e.g., in some geographic regions), traffic rules associated with short-dashed lane lines may permit vehicles to cross over (e.g., change lanes) and may be used to indicate a lane(s) that is going to end or otherwise deviate from another lane. As such, and based on the lateral pattern of the lane lines 302B and/or the topology of the road network as indicated in map data, the lane behavior determiner 104 may determine that the behaviors of the left lane 304B and the center lane 306B are each through lanes or lanes that continue straight along a road segment, while the behavior of the right lane 308B is an entry/exit lane where vehicles may merge from the right lane 308B to the center lane 306B (e.g., to merge onto a highway) and/or merge from the center lane 306B to the right lane 308B (e.g., to exit the highway).

Referring now to FIG. 3C, lane lines 302C associated with a left lane 304C, a center lane 306C, and a right lane 308C of a portion of a road network are illustrated. For instance, the left lane 304C may include a dashed line for its left lane line and a short-dashed line for its right lane line, the center lane 306C may include the short-dashed line for its left lane line and a short dashed line for its right lane line, and the right lane 308C may include the short-dashed line for its left lane line and a solid line for its right lane line. Based on the lateral pattern of the lane lines 302C and/or the topology of the road network as indicated in map data, the lane behavior determiner 104 may determine that the behavior of the left lane 304C is a through lane that continues straight along a road segment, while the behaviors of the center lane 306C and the right lane 308C are entry/exit lanes.

Referring next to FIG. 3D, lane lines 302D associated with a left lane 304D, a center lane 306D, and a right lane 308D of a portion of a road network are illustrated. For instance, the left lane 304D may include a dashed line for its left lane line and a short dashed line for its right lane line, the center lane 306D may include the short dashed line for its left lane line and a solid line for its right lane line, and the right lane 308D may include the solid line for its left lane line and another solid line for its right lane line. Based on the lateral pattern of the lane lines 302D, a history of the lane lines 302D (e.g., a tracked history of classifications of the lane lines 302D before this specific portion of the road), and/or the topology of the road network as indicated in map data, the lane behavior determiner 104 may determine that the behavior of the left lane 304D is a through lane that continues straight along a road segment, the behavior of the center lane 306D is an entry/exit lane, and the behavior of the right lane 308D is an exit only lane.

Referring now to FIG. 3E, lane lines 302E associated with a left lane 304E, a center lane 306E, and a right lane 308E of a portion of a road network are illustrated. For instance, the left lane 304E may include a dashed line for its left lane line and another dashed line for its right lane line, the center lane 306E may include the other dashed line for its left lane line and a short-dashed line for its right lane line, and the right lane 308E may include the short-dashed line for its left lane line and a solid line for its right lane line that deviates from being previously joined with the short-dashed, left lane line of the right lane 308E. Based on the lateral pattern of the lane lines 302E, a history of the lane lines 302E (e.g., a tracked history of classifications of the lane lines 302E before this specific portion of the road), and/or the topology of the road network, the lane behavior determiner 104 may determine that the behaviors of the left lane 304E and the center lane 306E are through lanes that continue straight along a road segment, while the behavior of the right lane 308E is a new exit lane.

Additionally, in some examples, the lane behavior determiner 104 may infer that one or more other lanes are located to the left of the left lane 304E based at least on the left lane line of the left lane 304E being a dashed lane line. Additionally, in some instances, the lane behavior determiner 104 may infer that one or more other lanes are located to the left of the left lane 304E based at least on map data indicating that a total number of lanes for this section of the road network is greater than three lanes.

Referring now to FIG. 3F, lane lines 302F associated with a left lane 304F, a center lane 306F, and a right lane 308F of a portion of a road network are illustrated. For instance, the left lane 304F may include a dashed line for its left lane line and another dashed line for its right lane line, the center lane 306F may include the other dashed line for its left lane line and a solid line that turns into a short-dashed line for its right lane line, and the right lane 308F may include a solid line that turns into the short-dashed line for its left lane line and a solid line for its right lane line. Based on the lateral pattern of the lane lines 302F, a history of the lane lines 302F (e.g., a tracked history of classifications of the lane lines 302F before this specific portion of the road), and/or the topology of the road network, the lane behavior determiner 104 may determine that the behaviors of the left lane 304F and the center lane 306F are through lanes that continue straight along a road segment, while the behavior of the right lane 308F is a new entrance lane. In some examples, the lane behavior determiner 104 may further determine whether the right lane 308F ends (e.g., merges into the center lane 306F) or becomes a new, adjacent lane to the center lane 306F. For instance, based on the topology of the road network, a number of lanes listed in the map data for this road section, and/or a determination of whether the short-dashed line eventually ends completely or turns into a long-dashed line, the lane behavior determiner 104 may determine whether the right lane 308F ends further down the road, merges into the center lane 306F, or becomes an exit lane.

While FIGS. 3A-3F illustrate just a few examples of different lane behaviors that may be determined from lane surface markings, in additional or alternative examples, any number of lane behaviors may be determined from any number of lane markings. For instance, while the examples of FIGS. 3A-3F illustrate three perceived lanes and four perceived lane lines 302, the system(s) of the present disclosure may perceive more or fewer lanes and/or lane lines. Additionally, the system(s) may determine any types of lane behaviors based on the classifications of the lane lines, patterns of the lane lines, geometries of the lane lines and/or the lanes, topology of the road network, and/or tracked histories of the lane lines.

Referring back to the example of FIG. 1, the process 100 may include the localization component 106 obtaining the lane behavior data 122 indicating the behaviors of the lanes in the perception data 116. The localization component 106 may use the lane behavior data 122, the sensor data 114, the perception data 116 (not shown), and/or the map data 124 to determine a lane-level location of the machine, which may be represented using the localization data 130. For instance, the localization component 106 may determine, based on the sensor data 114 and/or the perception data 116, lane line types associated with a lane the machine is operating in. The localization component 106 may also use the lane behavior data 122 and the map data 124 to determine which lanes lead to which road segments or how the lanes relate to the road segments. Based on which lanes lead to which road segments, the localization component 106 may match the lane the machine is using to the lanes matched to the road segments.

For example, if the lane information 128 of the map data 124 indicates that a section of a road includes five lanes (e.g., from left-to-right: a first lane, a second lane, a third lane, a fourth lane, and a fifth lane), and the road topology data 126 indicates that after a junction the road splits into two different segments, a left road segment having three lanes (e.g., the first lane, the second lane, and the third lane) and a right road segment having two lanes (e.g., the fourth lane and the fifth lane), the localization component 106 may use the lane behavior data 122 to determine which lanes lead to which of the two different road segments. Additionally, the localization component 106 may use the sensor data 114 and/or the perception data 116 to determine which one of the five lanes the machine is using at a current timestamp. For instance, if the perception data 116 indicates that the machine is in a lane having dashed lane lines on both sides, and that a lane to the immediate left of the machine includes a solid left lane line and that a lane to the immediate right of the machine includes a short-dashed right lane line (e.g., as if the machine was operating in the center lane 306A in the example of FIG. 3A), the localization component 106 may determine that the current lane used by the machine is the second lane, and that the second lane is a through traffic lane to proceed on to the left road segment at the junction.

As described herein, the localization data 130 may indicate lane-level locations of the machine, in some instances. For example, in contrast to determining road-level localizations of the machine—which may indicate where, in in relation to a segment of a road, a machine is located (e.g., start of the road segment, end of the road segment, etc.)—the lane-level localizations determined by the localization component 106 using the lane behavior data 122 may indicate which lane of a road segment the machine is using, where the lane leads to, how the lane relates to other lanes of the road segment and/or other road segments, etc. Without lane-level localizations, the possibility of the machine making incorrect or less than optimal navigation decisions may be increased, such as using an incorrect or non-optimal lane for navigating a route, missing turns, making last-second lane changes, etc. For instance, the route planner 108 may use the map data 124 to generate the route data 132, which may represent road-level routes for the machine to follow. Such a road-level route may indicate, as an example, for the machine to use a first road segment, then turn right onto a second road segment, then turn left onto a third road segment, and so forth, potentially without including certain important details (e.g., use the right-most lane to turn right onto the second road segment, use any of the two, left-most lanes to follow onto the third road segment, etc.).

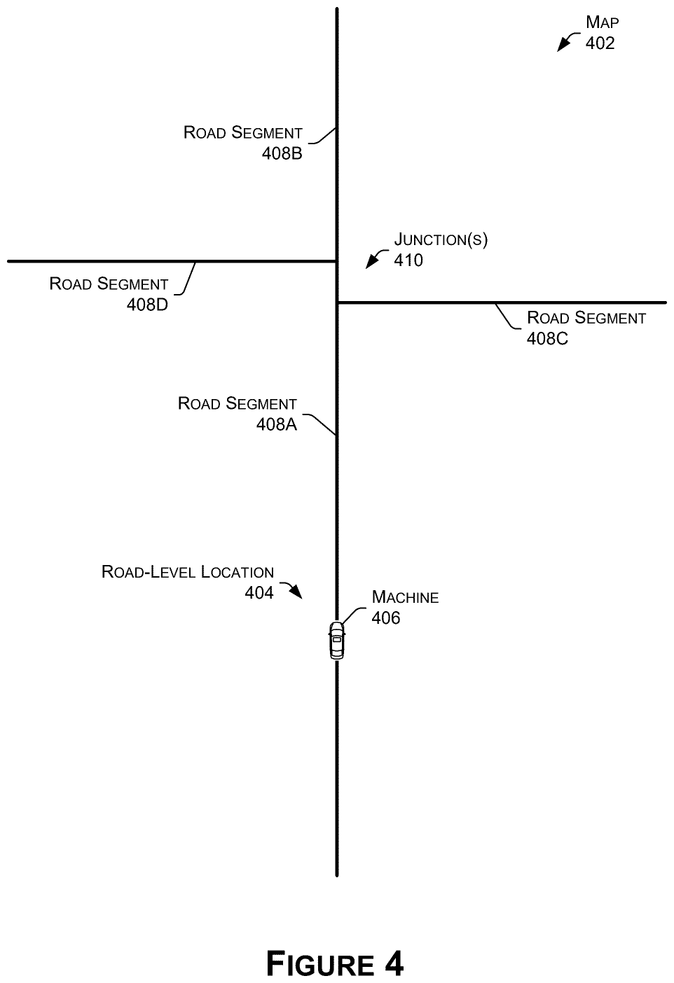

For instance, FIG. 4 illustrates an example of a map 402, in accordance with some embodiments of the present disclosure. The map 402 may correspond to a navigation, SD map, as described herein, that may be used by the route planner 108 to generate the route data 132. In some examples, the map data 124 described with respect to the example of FIG. 1 may represent a navigation, SD map that is similar to the map 402. The example of FIG. 4 also illustrates an example of a road-level location 404 of a machine 406 (which may correspond to the machine 1000). For instance, the map 402 indicates a road network topology that includes a first road segment 408A, a second road segment 408B, a third road segment 408C, and a fourth road segment 408D, and the road-level location 404 indicates the machine 406 is operating on the first road segment 408A and heading toward a junction(s) 410 of the road segments 408A-408D. However, the road-level location 404 illustrated in the example of FIG. 4 does not indicate which lane the machine 406 is using, as well as potentially other important details for navigating the junction(s) 410 in accordance with an intended or defined route of the machine 406. As such, if the route of the machine 406 is to use the first road segment 408A and then use the second road segment 408B, the map 402, and/or the route data 132 generated using the map 402, may not include certain, important details for navigating the route.

Referring back to the example of FIG. 1, the process 100 may include the path planner 110 using the lane-level, localization data 130 and the road-level, route data 132 to generate path data 134, which may represent a lane-level path for the machine to use to navigate the route represented in the route data 132. For instance, the path data 134 may indicate which lanes (e.g., optimal lanes) for the machine to use for the route, a trajectory for the machine to follow to navigate the route using the lanes, etc. That is, the path planner 110 may update the route and/or the map of the route to include additional detail and context for the machine to make navigational decisions.

In some examples, to determine or refine the path for the machine, the path planner 110 may obtain the route data 132 indicating the road segments to use to navigate from a first location to a second location. The path planner 110 may use the lane behavior data 122 to determine which lanes should be used for which road segments. That is, the path planner 110 may determine which lanes lead to which road segments based on the predicted lane behaviors and the topology of the road network indicated in the navigation or SD map. Based on determining which lane(s) should be used for the road segments of the route, the path planner 110 may determine whether the machine is using that/those lane(s). For instance, the path planner 110 may use the localization data 130 to determine which lane the machine is using. The path planner 110 may plan the path of the machine based on the machine's current location. For instance, if the machine is using an incorrect or non-optimal lane, the path planner 110 may plan a path for the machine to cause the machine to change lanes or otherwise alter the machine's current/previous path.

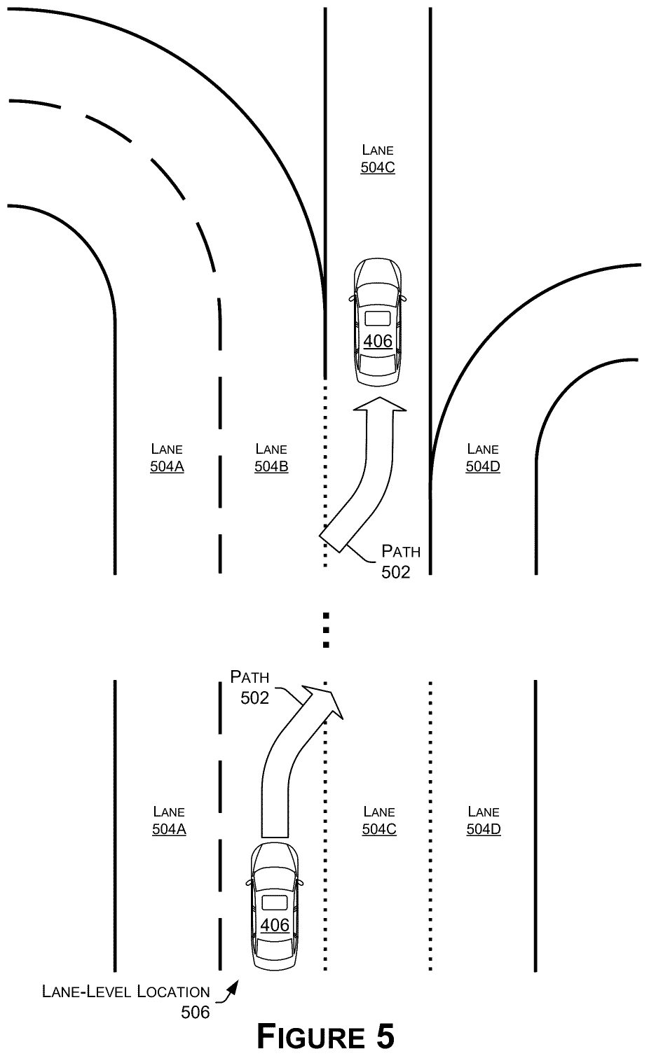

For instance, FIG. 5 illustrates an example of using lane behavior to plan a path 502 for the machine 406 to follow that corresponds to a route of the machine 406, in accordance with some embodiments of the present disclosure. In the example of FIG. 5, the geometries of the different lanes 504A-504D may correspond to the topology of the road segments 408A-408D of the map 402 in the example of FIG. 4. For instance, the lanes 504A-504D may correspond to the first road segment 408A, then, based on the junction(s) 410, the first lane 504A and the second lane 504B may correspond to the fourth road segment 408D, the third lane 504C may correspond to the second road segment 408B, and the fourth lane 504D may correspond to the third road segment 408C. As such, if the route of the machine 406 is to use the first road segment 408A and the second road segment 408B, the machine 406 may need to use the third lane 504C.

However, as shown in the example of FIG. 5, the machine 406 may initially be using the second lane 504B. For instance, if the route of the machine 406 does not include any path-level data, the machine 406 may use the incorrect lane. However, by using the techniques of the present disclosure, the localization component 106 and the path planner 110 may use the lane behavior data 122 to determine a lane-level location 506 of the machine 406, determine that the machine 406 is using the incorrect lane for the route, and determine the path 502—which may be represented using the path data 134—to cause the machine 406 to change lanes from the second lane 504B (e.g., the incorrect lane) to the third lane 504C (e.g., the correct lane).

Referring back to the example of FIG. 1, the process 100 may include the drive stack component(s) 112 obtaining the path data 134 and using the path data 134 to cause the machine to perform one or more operations. Additionally, or alternatively, while not shown, the drive stack component(s) 112 may obtain or receive any of the sensor data 114, the perception data 116, the lane behavior data 122, the map data 124, the route data 132, and/or the localization data 130 and use the data to cause the machine to perform the operation(s). In some examples, the drive stack component(s) 112 may use the data as inputs to other models, algorithms, processes, or other system(s) associated with the machine. The drive stack component(s) 112 may include any of the components described with respect to the machine 1000 of FIGS. 10A-10D.

In at least one example, the drive stack component(s) 112 may use the data (e.g., the lane behavior data 122, the localization data 130, etc.) to update or refine the map data 124. For instance, the drive stack component(s) 112 may update the lane information 128 of the map data 124 to indicate the behaviors of the lanes of the road network. Such updating may include embedding or fusing semantic data with the map data 124 to indicate the behaviors of the lanes. In some examples, this updated map data 124 may be provided to other machines for traversing the environment, or stored by the machine for subsequent use.

In at least one example, the drive stack component(s) 112 may use the path data 134 to plan a trajectory for the machine to follow. The trajectory may define a velocity, acceleration, steering angle, heading, etc. for the machine. The drive stack component(s) 112 may take into account traffic rules, locations of obstacles, and/or other parameters to determine the trajectory for the machine to follow the path indicated in the path data 134. For instance, a trajectory may indicate that the machine needs to decelerate (e.g., to allow another vehicle to pass the machine) in order for the machine to change lanes. While these are just a couple examples, in additional or alternative examples, the drive stack component(s) 112 and/or any other components, systems, or modules of the machine may use the lane behavior data 122, the path data 134, and/or any of the other data described with respect to the example of FIG. 1 to cause the machine to perform any number of operations.

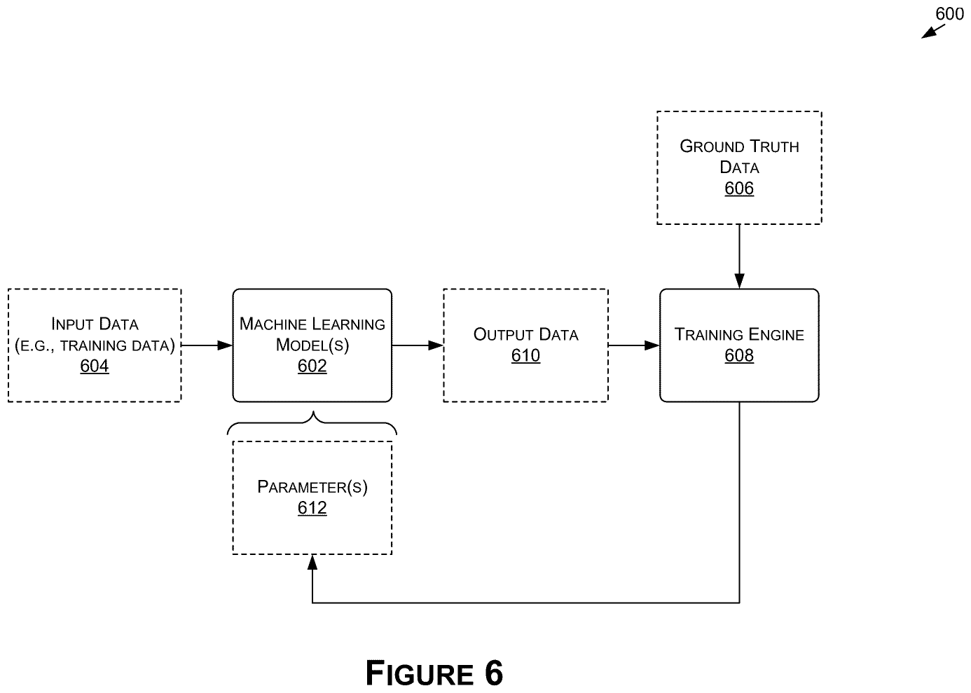

Referring now to FIG. 6, FIG. 6 is a data flow diagram illustrating an example of a process 600 for training one or more machine learning models to perform one or more aspects associated with one or more of the processes described herein, in accordance with some embodiments of the present disclosure. For instance, the machine learning model(s) 602 may correspond to, or be used to perform the functionality of, one or more of the perception component 102, the lane behavior determiner 104, the localization component 106, the route planner 108, the path planner 110, and/or the drive stack component(s) 112. In at least one example, the machine learning model(s) 602 may be trained to determine the correct traffic rules for different types of lane lines in different geographic areas (e.g., different cities, counties, states, countries, continents, etc.).

As shown, the machine learning model(s) 602 may be trained using various input data 604 (e.g., training input data). In some examples, the input data 604 may include one or more actual (e.g., previously generated and/or stored) versions of the sensor data 114, the perception data 116, the lane behavior data 122, the map data 124, the localization data 130, the route data 132, the path data 134, etc. Additionally, or alternatively, the input data 604 may be based on the actual versions of the sensor data 114, the perception data 116, the lane behavior data 122, the map data 124, the localization data 130, the route data 132, and/or the path data 134. For instance, the input data 604 may include one or more modified versions of the sensor data 114, the perception data 116, the lane behavior data 122, the map data 124, the localization data 130, the route data 132, and/or the path data 134.

The machine learning model(s) 602 may be trained using the input data 604 as well as corresponding ground truth data 606. The ground truth data 606 may include annotations, labels, masks, and/or the like. For example, in some embodiments, the ground truth data 606 may indicate actual values of parameters associated with lane line markings, lane behaviors (e.g., lane roles, classifications, uses, etc.), lane-level localizations, lane-level machine paths, and/or the input data 604. For instance, the parameters in the ground truth data 606 may include, but are not limited to, lane behaviors, machine paths (e.g., lane-level paths), machine locations (e.g., lane-level locations), lane line classifications, traffic rules for lanes and/or lane lines, traffic rules for lane lines for different geographic areas, locations of lane lines, patterns between lane lines, and/or any other parameter. The ground truth data 606 may be generated within a drawing program (e.g., an annotation program), a computer aided design (CAD) program, a labeling program, another type of program suitable for generating the ground truth data 606, and/or may be hand drawn, in some examples. In any example, the ground truth data 606 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof (e.g., human identifies vertices of polylines, machine generates polygons using polygon rasterizer).

A training engine 608 may use one or more loss functions that measure loss (e.g., error) in output data 610 generated by the machine learning model(s) 602 as compared to the ground truth data 606. The output data 610 may include or correspond to the perception data 116, the lane behavior data 122, the localization data 130, the route data 132, the path data 134, and/or any other outputs described herein. In some examples, any type of loss function may be used, such as cross entropy loss, mean squared error, mean absolute error, mean bias error, and/or other loss function types. In some examples, different outputs may have different loss functions. For example, a first predicted path behavior may include a first loss, a second predicted path behavior may include a second loss, a third predicted path behavior may include a third loss, and/or so forth. In such examples, the loss functions may be combined to form a total loss, and the total loss may be used by the training engine 608 to train the machine learning model(s) 602 by, in some instances, updating a parameter(s) 612 (e.g., weights, biases, etc.) of the machine learning model(s) 602. In any example, backward pass computations may be performed to recursively compute gradients of the loss function(s) with respect to training parameters. In some examples, weights and biases of the machine learning model(s) 602 may be used to compute these gradients.

The machine learning model(s) 602 may use any type of machine learning technologies and/or algorithms. For example, and without limitation, any of the various machine learning models described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

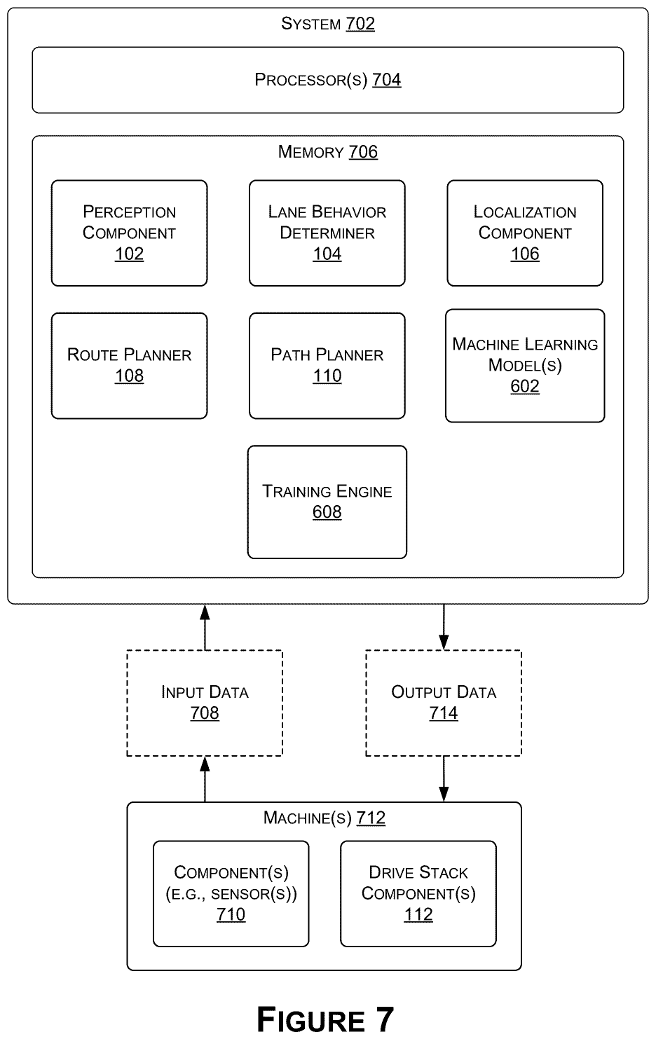

Referring now to FIG. 7, FIG. 7 illustrates an example of a system 702 that may perform one or more of the processes described herein, in accordance with some embodiments of the present disclosure. As shown, the system 702 (which may represent, and/or include, the example computing device(s) 1100 and/or the example data center 1200) may include one or more processors 704 (which may be similar to, and/or include, the CPUs 1106 and/or the GPUs 1108) and memory 706 (which may be similar to, and/or include, the memory 1104). For instance, the memory 706 may store one or more of the perception component 102, the lane behavior determiner 104, the localization component 106, the route planner 108, the path planner 110, the machine learning model(s) 602, and/or the training engine 608. Additionally, the processor(s) 704 may execute one or more of the perception component 102, the lane behavior determiner 104, the localization component 106, the route planner 108, the path planner 110, the machine learning model(s) 602, and/or the training engine 608 to perform one or more of the processes described herein.

For instance, the system 702 may receive input data 708 generated by one or more components 710 (e.g., one or more sensors) of one or more machines 712, which may correspond to the machine 1000 described herein. The input data 708 may include one or more of the sensor data 114, the perception data 116, the map data 124, and/or any other data described herein. The system 702 may then process and evaluate the input data 708 in order to determine behaviors of lanes of a road network and/or determine whether the machine(s) 712 is using an optimal lane for a route. The system 702 may send output data 714, which may include the lane behavior data 122, the localization data 130, the path data 134, and/or any other output data described herein. The drive stack component(s) 112 of the machine(s) 712 may use the output data 714 to control one or more operations of the machine(s) 712. Although depicted as being separate systems, the system 702 and the machine(s) 712 may, in some examples, be the same or different systems. For instance, the processor(s) 704 and the memory 706 may be part of the machine(s) 712 (e.g., included within a computing device of the machine(s) 712).

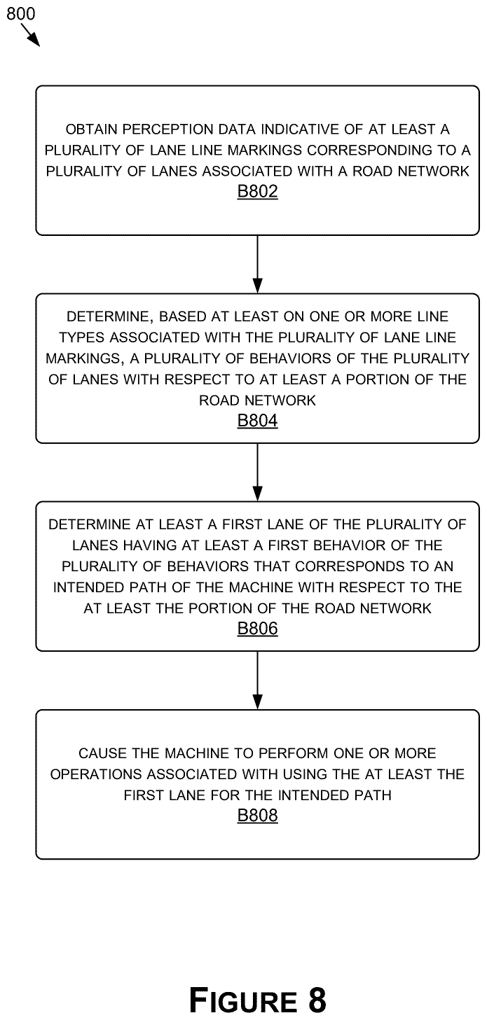

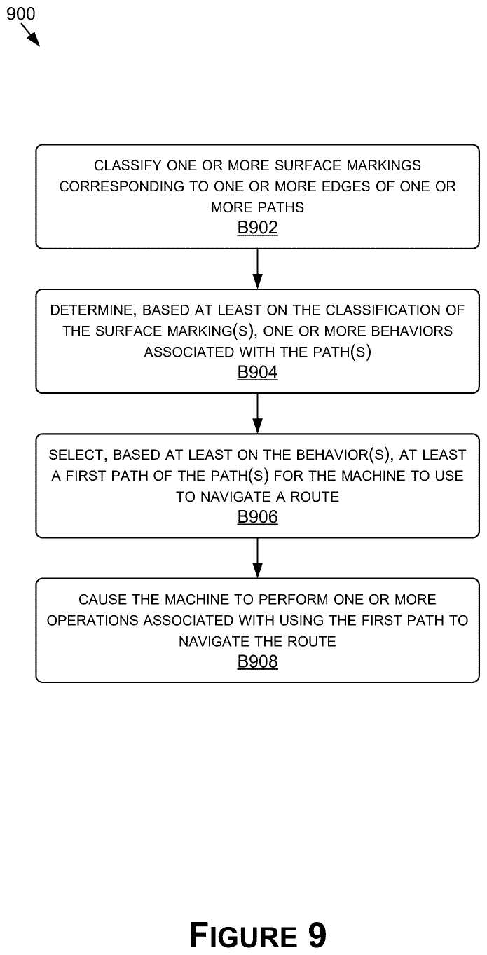

Now referring to FIGS. 8 and 9, each block of methods 800 and 900, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods 800 and 900 are described, by way of example, with respect to FIG. 1. However, these methods may additionally or alternatively be executed by any one system, or any combination of systems, including, but not limited to, those described herein.

FIG. 8 is a flow diagram illustrating an example of a method 800 for using lane behaviors to determine whether a machine is using a correct lane to navigate a route, in accordance with some embodiments of the present disclosure. The method 800, at block B802, may include obtaining perception data indicative of at least a plurality of lane line markings corresponding to a plurality of lanes associated with a road network. For instance, the lane behavior determiner 104 may obtain the perception data 116 generated by the perception component 102. The perception data 116 may include the surface marking data 118 indicative of the plurality of lane line markings corresponding to the plurality of lanes associated with the road network.

The method 800, at block B804, may include determining, based at least on one or more line types associated with the plurality of lane line markings, a plurality of behaviors of the plurality of lanes with respect to at least a portion of the road network. For instance, the lane behavior determiner 104 may determine the lane behavior data 122 based at least on the line type(s) associated with the plurality of lane line markings. The lane behavior data 122 may indicate the plurality of behaviors of the plurality of lanes with respect to the portion of the road network. For instance, the lane behavior data 122 may indicate which lanes lead to which road segments of the road network, roles of each lane (e.g., exit lane, through traffic lane, etc.), etc.

The method 800, at block B806, may include determining at least a first lane of the plurality of lanes having at least a first behavior of the plurality of behaviors that corresponds to an intended path of the machine with respect to the at least the portion of the road network. For instance, the path planner 110 may determine the first lane having the first behavior that corresponds to the intended path of the machine with respect to the portion of the road network. In some examples, whether the first behavior corresponds to the intended path may include whether the first lane leads to a specific road segment that is part of the intended path. For instance, if the intended path includes a right turn from a first road segment to a second road segment, and the behavior of the lane is a right turn lane or exit lane, the system(s) may determine the behavior corresponds to the intended path.

The method 800, at block B808, may include causing the machine to perform one or more operations associated with using the at least the first lane for the intended path. For instance, the drive stack component(s) 112 may receive the path data 134 and cause the machine to perform the operation(s) associated with using the first lane for the intended path. In some examples, the operation(s) may include determining or altering a trajectory of the machine (e.g., to cause the machine to change lanes to an optimal or correct lane, to continue following the current lane if the current lane is the correct or optimal lane, etc.).

FIG. 9 is a flow diagram illustrating an example of a method 900 for selecting a path for a machine based at least on a behavior of the path, in accordance with some embodiments of the present disclosure. The method 900, at block B902, may include classifying one or more surface markings corresponding to one or more edges of one or more paths. For instance, the perception component 102 or the lane behavior determiner 104 may classify the surface marking(s) corresponding to the edges of the path(s). Classifying the surface marking(s) may include, in some examples, classifying line types associated with the surface marking(s), such as whether the surface marking(s) are dashed lines, solid lines, short-dashed lines, etc. In some examples, classifying the surface marking(s) may include determining traffic rules corresponding to the surface marking(s).

The method 900, at block B904, may include determining, based at least on the classification of the surface marking(s), one or more behaviors associated with the path(s). For instance, the lane behavior determiner 104 may determine the lane behavior data 122 based at least on classifications associated with the surface marking(s), such as types of line markings, arrow marks, etc. associated with the path(s). The lane behavior data 122 may indicate the behavior(s) of the path(s) with respect to the portion of the road network. For instance, the lane behavior data 122 may indicate which paths lead to which road segments of the road network, roles of each path (e.g., exit lane, through traffic lane), etc.

The method 900, at block B906, may include selecting, based at least on the behavior(s), at least a first path of the path(s) for the machine to use to navigate a route. For instance, the path planner 110 may select the first path for the machine to use to navigate the route based at least on the lane behavior data 122. In some examples, the path planner 110 may compare the lane behavior data 122 to the route data 132 to select the first path as an optimal path. In some instances, the optimal path may include a correct path that follows the navigation route and has the least traffic, shortest distance, does not require unnecessary lane changes, takes into account future turns or maneuvers (e.g., if a right turn is coming up use the closest lane to a turning lane, etc.).

The method 900, at block B908, may include causing the machine to perform one or more operations associated with using the first path to navigate the route. For instance, the drive stack component(s) 112 may receive the path data 134 and cause the machine to perform the operation(s) associated with using the first path to navigate the route. In some examples, the operation(s) may include determining or altering a trajectory of the machine (e.g., to cause the machine to change paths to an optimal or correct path, to continue following the current path if the current path is the correct or optimal path, etc.).

### Example Autonomous Vehicle

FIG. 10A is an illustration of an example autonomous vehicle 1000, in accordance with some embodiments of the present disclosure. The autonomous vehicle 1000 (alternatively referred to herein as the “vehicle 1000”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1000 may be capable of functionality in accordance with one or more of Level 3-Level 5 of the autonomous driving levels. The vehicle 1000 may be capable of functionality in accordance with one or more of Level 1-Level 5 of the autonomous driving levels. For example, the vehicle 1000 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1000 or other machine, such as being fully autonomous, being highly autonomous, being conditionally autonomous, being partially autonomous, providing assistive autonomy, being semi-autonomous, being primarily autonomous, or other designation.

The vehicle 1000 may include components such as a chassis, a vehicle body, wheels (e.g., 2, 4, 6, 8, 18, etc.), tires, axles, and other components of a vehicle. The vehicle 1000 may include a propulsion system 1050, such as an internal combustion engine, hybrid electric power plant, an all-electric engine, and/or another propulsion system type. The propulsion system 1050 may be connected to a drive train of the vehicle 1000, which may include a transmission, to enable the propulsion of the vehicle 1000. The propulsion system 1050 may be controlled in response to receiving signals from the throttle/accelerator 1052.

A steering system 1054, which may include a steering wheel, may be used to steer the vehicle 1000 (e.g., along a desired path or route) when the propulsion system 1050 is operating (e.g., when the vehicle is in motion). The steering system 1054 may receive signals from a steering actuator 1056. The steering wheel may be optional for full automation (Level 5) functionality.

The brake sensor system 1046 may be used to operate the vehicle brakes in response to receiving signals from the brake actuators 1048 and/or brake sensors.

Controller(s) 1036, which may include one or more system on chips (SoCs) 1004 (FIG. 10C) and/or GPU(s), may provide signals (e.g., representative of commands) to one or more components and/or systems of the vehicle 1000. For example, the controller(s) may send signals to operate the vehicle brakes via one or more brake actuators 1048, to operate the steering system 1054 via one or more steering actuators 1056, to operate the propulsion system 1050 via one or more throttle/accelerators 1052. The controller(s) 1036 may include one or more onboard (e.g., integrated) computing devices (e.g., supercomputers) that process sensor signals, and output operation commands (e.g., signals representing commands) to enable autonomous driving and/or to assist a human driver in driving the vehicle 1000. The controller(s) 1036 may include a first controller 1036 for autonomous driving functions, a second controller 1036 for functional safety functions, a third controller 1036 for artificial intelligence functionality (e.g., computer vision), a fourth controller 1036 for infotainment functionality, a fifth controller 1036 for redundancy in emergency conditions, and/or other controllers. In some examples, a single controller 1036 may handle two or more of the above functionalities, two or more controllers 1036 may handle a single functionality, and/or any combination thereof.

The controller(s) 1036 may provide the signals for controlling one or more components and/or systems of the vehicle 1000 in response to sensor data received from one or more sensors (e.g., sensor inputs). The sensor data may be received from, for example and without limitation, global navigation satellite systems (“GNSS”) sensor(s) 1058 (e.g., Global Positioning System sensor(s)), RADAR sensor(s) 1060, ultrasonic sensor(s) 1062, LIDAR sensor(s) 1064, inertial measurement unit (IMU) sensor(s) 1066 (e.g., accelerometer(s), gyroscope(s), magnetic compass(es), magnetometer(s), etc.), microphone(s) 1096, stereo camera(s) 1068, wide-view camera(s) 1070 (e.g., fisheye cameras), infrared camera(s) 1072, surround camera(s) 1074 (e.g., 360 degree cameras), long-range and/or mid-range camera(s) 1098, speed sensor(s) 1044 (e.g., for measuring the speed of the vehicle 1000), vibration sensor(s) 1042, steering sensor(s) 1040, brake sensor(s) (e.g., as part of the brake sensor system 1046), and/or other sensor types.

One or more of the controller(s) 1036 may receive inputs (e.g., represented by input data) from an instrument cluster 1032 of the vehicle 1000 and provide outputs (e.g., represented by output data, display data, etc.) via a human-machine interface (HMI) display 1034, an audible annunciator, a loudspeaker, and/or via other components of the vehicle 1000. The outputs may include information such as vehicle velocity, speed, time, map data (e.g., the High Definition (“HD”) map 1022 of FIG. 10C), location data (e.g., the vehicle's 1000 location, such as on a map), direction, location of other vehicles (e.g., an occupancy grid), information about objects and status of objects as perceived by the controller(s) 1036, etc. For example, the HMI display 1034 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1000 further includes a network interface 1024 which may use one or more wireless antenna(s) 1026 and/or modem(s) to communicate over one or more networks. For example, the network interface 1024 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1026 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 10B is an example of camera locations and fields of view for the example autonomous vehicle 1000 of FIG. 10A, in accordance with some embodiments of the present disclosure. The cameras and respective fields of view are one example embodiment and are not intended to be limiting. For example, additional and/or alternative cameras may be included and/or the cameras may be located at different locations on the vehicle 1000.

The camera types for the cameras may include, but are not limited to, digital cameras that may be adapted for use with the components and/or systems of the vehicle 1000. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1000 (e.g., front-facing cameras) may be used for surround view, to help identify forward facing paths and obstacles, as well aid in, with the help of one or more controllers 1036 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1070 that may be used to perceive objects coming into view from the periphery (e.g., pedestrians, crossing traffic or bicycles). Although only one wide-view camera is illustrated in FIG. 10B, there may be any number (including zero) of wide-view cameras 1070 on the vehicle 1000. In addition, any number of long-range camera(s) 1098 (e.g., a long-view stereo camera pair) may be used for depth-based object detection, especially for objects for which a neural network has not yet been trained. The long-range camera(s) 1098 may also be used for object detection and classification, as well as basic object tracking.

Any number of stereo cameras 1068 may also be included in a front-facing configuration. In at least one embodiment, one or more of stereo camera(s) 1068 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1068 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1068 may be used in addition to, or alternatively from, those described herein.

Cameras with a field of view that include portions of the environment to the side of the vehicle 1000 (e.g., side-view cameras) may be used for surround view, providing information used to create and update the occupancy grid, as well as to generate side impact collision warnings. For example, surround camera(s) 1074 (e.g., four surround cameras 1074 as illustrated in FIG. 10B) may be positioned to on the vehicle 1000. The surround camera(s) 1074 may include wide-view camera(s) 1070, fisheye camera(s), 360 degree camera(s), and/or the like. Four example, four fisheye cameras may be positioned on the vehicle's front, rear, and sides. In an alternative arrangement, the vehicle may use three surround camera(s) 1074 (e.g., left, right, and rear), and may leverage one or more other camera(s) (e.g., a forward-facing camera) as a fourth surround view camera.

Cameras with a field of view that include portions of the environment to the rear of the vehicle 1000 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1098, stereo camera(s) 1068), infrared camera(s) 1072, etc.), as described herein.

FIG. 10C is a block diagram of an example system architecture for the example autonomous vehicle 1000 of FIG. 10A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1000 in FIG. 10C are illustrated as being connected via bus 1002. The bus 1002 may include a Controller Area Network (CAN) data interface (alternatively referred to herein as a “CAN bus”). A CAN may be a network inside the vehicle 1000 used to aid in control of various features and functionality of the vehicle 1000, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1002 is described herein as being a CAN bus, this is not intended to be limiting. For example, in addition to, or alternatively from, the CAN bus, FlexRay and/or Ethernet may be used. Additionally, although a single line is used to represent the bus 1002, this is not intended to be limiting. For example, there may be any number of busses 1002, which may include one or more CAN busses, one or more FlexRay busses, one or more Ethernet busses, and/or one or more other types of busses using a different protocol. In some examples, two or more busses 1002 may be used to perform different functions, and/or may be used for redundancy. For example, a first bus 1002 may be used for collision avoidance functionality and a second bus 1002 may be used for actuation control. In any example, each bus 1002 may communicate with any of the components of the vehicle 1000, and two or more busses 1002 may communicate with the same components. In some examples, each SoC 1004, each controller 1036, and/or each computer within the vehicle may have access to the same input data (e.g., inputs from sensors of the vehicle 1000), and may be connected to a common bus, such the CAN bus.

The vehicle 1000 may include one or more controller(s) 1036, such as those described herein with respect to FIG. 10A. The controller(s) 1036 may be used for a variety of functions. The controller(s) 1036 may be coupled to any of the various other components and systems of the vehicle 1000, and may be used for control of the vehicle 1000, artificial intelligence of the vehicle 1000, infotainment for the vehicle 1000, and/or the like.

The vehicle 1000 may include a system(s) on a chip (SoC) 1004. The SoC 1004 may include CPU(s) 1006, GPU(s) 1008, processor(s) 1010, cache(s) 1012, accelerator(s) 1014, data store(s) 1016, and/or other components and features not illustrated. The SoC(s) 1004 may be used to control the vehicle 1000 in a variety of platforms and systems. For example, the SoC(s) 1004 may be combined in a system (e.g., the system of the vehicle 1000) with an HD map 1022 which may obtain map refreshes and/or updates via a network interface 1024 from one or more servers (e.g., server(s) 1078 of FIG. 10D).

The CPU(s) 1006 may include a CPU cluster or CPU complex (alternatively referred to herein as a “CCPLEX”). The CPU(s) 1006 may include multiple cores and/or L2 caches. For example, in some embodiments, the CPU(s) 1006 may include eight cores in a coherent multi-processor configuration. In some embodiments, the CPU(s) 1006 may include four dual-core clusters where each cluster has a dedicated L2 cache (e.g., a 2 MB L2 cache). The CPU(s) 1006 (e.g., the CCPLEX) may be configured to support simultaneous cluster operation enabling any combination of the clusters of the CPU(s) 1006 to be active at any given time.

The CPU(s) 1006 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1006 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1008 may include an integrated GPU (alternatively referred to herein as an “iGPU”). The GPU(s) 1008 may be programmable and may be efficient for parallel workloads. The GPU(s) 1008, in some examples, may use an enhanced tensor instruction set. The GPU(s) 1008 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1008 may include at least eight streaming microprocessors. The GPU(s) 1008 may use compute application programming interface(s) (API(s)). In addition, the GPU(s) 1008 may use one or more parallel computing platforms and/or programming models (e.g., NVIDIA's CUDA).

The GPU(s) 1008 may be power-optimized for best performance in automotive and embedded use cases. For example, the GPU(s) 1008 may be fabricated on a Fin field-effect transistor (FinFET). However, this is not intended to be limiting and the GPU(s) 1008 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1008 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1008 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1008 to access the CPU(s) 1006 page tables directly. In such examples, when the GPU(s) 1008 memory management unit (MMU) experiences a miss, an address translation request may be transmitted to the CPU(s) 1006. In response, the CPU(s) 1006 may look in its page tables for the virtual-to-physical mapping for the address and transmits the translation back to the GPU(s) 1008. As such, unified memory technology may allow a single unified virtual address space for memory of both the CPU(s) 1006 and the GPU(s) 1008, thereby simplifying the GPU(s) 1008 programming and porting of applications to the GPU(s) 1008.

In addition, the GPU(s) 1008 may include an access counter that may keep track of the frequency of access of the GPU(s) 1008 to memory of other processors. The access counter may help ensure that memory pages are moved to the physical memory of the processor that is accessing the pages most frequently.

The SoC(s) 1004 may include any number of cache(s) 1012, including those described herein. For example, the cache(s) 1012 may include an L3 cache that is available to both the CPU(s) 1006 and the GPU(s) 1008 (e.g., that is connected both the CPU(s) 1006 and the GPU(s) 1008). The cache(s) 1012 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1004 may include an arithmetic logic unit(s) (ALU(s)) which may be leveraged in performing processing with respect to any of the variety of tasks or operations of the vehicle 1000—such as processing DNNs. In addition, the SoC(s) 1004 may include a floating point unit(s) (FPU(s))—or other math coprocessor or numeric coprocessor types—for performing mathematical operations within the system. For example, the SoC(s) 1004 may include one or more FPUs integrated as execution units within a CPU(s) 1006 and/or GPU(s) 1008.

The SoC(s) 1004 may include one or more accelerators 1014 (e.g., hardware accelerators, software accelerators, or a combination thereof). For example, the SoC(s) 1004 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1008 and to off-load some of the tasks of the GPU(s) 1008 (e.g., to free up more cycles of the GPU(s) 1008 for performing other tasks). As an example, the accelerator(s) 1014 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1014 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1008, and by using an inference accelerator, for example, a designer may target either the DLA(s) or the GPU(s) 1008 for any function. For example, the designer may focus processing of CNNs and floating point operations on the DLA(s) and leave other functions to the GPU(s) 1008 and/or other accelerator(s) 1014.

The accelerator(s) 1014 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1006. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1014 (e.g., the hardware acceleration cluster) may include a computer vision network on-chip and SRAM, for providing a high-bandwidth, low latency SRAM for the accelerator(s) 1014. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1004 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1014 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1066 output that correlates with the vehicle 1000 orientation, distance, 3D location estimates of the object obtained from the neural network and/or other sensors (e.g., LIDAR sensor(s) 1064 or RADAR sensor(s) 1060), among others.

The SoC(s) 1004 may include data store(s) 1016 (e.g., memory). The data store(s) 1016 may be on-chip memory of the SoC(s) 1004, which may store neural networks to be executed on the GPU and/or the DLA. In some examples, the data store(s) 1016 may be large enough in capacity to store multiple instances of neural networks for redundancy and safety. The data store(s) 1012 may comprise L2 or L3 cache(s) 1012. Reference to the data store(s) 1016 may include reference to the memory associated with the PVA, DLA, and/or other accelerator(s) 1014, as described herein.

The SoC(s) 1004 may include one or more processor(s) 1010 (e.g., embedded processors). The processor(s) 1010 may include a boot and power management processor that may be a dedicated processor and subsystem to handle boot power and management functions and related security enforcement. The boot and power management processor may be a part of the SoC(s) 1004 boot sequence and may provide runtime power management services. The boot power and management processor may provide clock and voltage programming, assistance in system low power state transitions, management of SoC(s) 1004 thermals and temperature sensors, and/or management of the SoC(s) 1004 power states. Each temperature sensor may be implemented as a ring-oscillator whose output frequency is proportional to temperature, and the SoC(s) 1004 may use the ring-oscillators to detect temperatures of the CPU(s) 1006, GPU(s) 1008, and/or accelerator(s) 1014. If temperatures are determined to exceed a threshold, the boot and power management processor may enter a temperature fault routine and put the SoC(s) 1004 into a lower power state and/or put the vehicle 1000 into a chauffeur to safe stop mode (e.g., bring the vehicle 1000 to a safe stop).

The processor(s) 1010 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1010 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1010 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1010 may further include a real-time camera engine that may include a dedicated processor subsystem for handling real-time camera management.

The processor(s) 1010 may further include a high-dynamic range signal processor that may include an image signal processor that is a hardware engine that is part of the camera processing pipeline.

The processor(s) 1010 may include a video image compositor that may be a processing block (e.g., implemented on a microprocessor) that implements video post-processing functions needed by a video playback application to produce the final image for the player window. The video image compositor may perform lens distortion correction on wide-view camera(s) 1070, surround camera(s) 1074, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1008 is not required to continuously render new surfaces. Even when the GPU(s) 1008 is powered on and active doing 3D rendering, the video image compositor may be used to offload the GPU(s) 1008 to improve performance and responsiveness.

The SoC(s) 1004 may further include a mobile industry processor interface (MIPI) camera serial interface for receiving video and input from cameras, a high-speed interface, and/or a video input block that may be used for camera and related pixel input functions. The SoC(s) 1004 may further include an input/output controller(s) that may be controlled by software and may be used for receiving I/O signals that are uncommitted to a specific role.

The SoC(s) 1004 may further include a broad range of peripheral interfaces to enable communication with peripherals, audio codecs, power management, and/or other devices. The SoC(s) 1004 may be used to process data from cameras (e.g., connected over Gigabit Multimedia Serial Link and Ethernet), sensors (e.g., LIDAR sensor(s) 1064, RADAR sensor(s) 1060, etc. that may be connected over Ethernet), data from bus 1002 (e.g., speed of vehicle 1000, steering wheel position, etc.), data from GNSS sensor(s) 1058 (e.g., connected over Ethernet or CAN bus). The SoC(s) 1004 may further include dedicated high-performance mass storage controllers that may include their own DMA engines, and that may be used to free the CPU(s) 1006 from routine data management tasks.

The SoC(s) 1004 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1004 may be faster, more reliable, and even more energy-efficient and space-efficient than conventional systems. For example, the accelerator(s) 1014, when combined with the CPU(s) 1006, the GPU(s) 1008, and the data store(s) 1016, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1020) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1008.

In some examples, a CNN for facial recognition and vehicle owner identification may use data from camera sensors to identify the presence of an authorized driver and/or owner of the vehicle 1000. The always on sensor processing engine may be used to unlock the vehicle when the owner approaches the driver door and turn on the lights, and, in security mode, to disable the vehicle when the owner leaves the vehicle. In this way, the SoC(s) 1004 provide for security against theft and/or carjacking.

In another example, a CNN for emergency vehicle detection and identification may use data from microphones 1096 to detect and identify emergency vehicle sirens. In contrast to conventional systems, that use general classifiers to detect sirens and manually extract features, the SoC(s) 1004 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1058. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1062, until the emergency vehicle(s) passes.

The vehicle may include a CPU(s) 1018 (e.g., discrete CPU(s), or dCPU(s)), that may be coupled to the SoC(s) 1004 via a high-speed interconnect (e.g., PCIe). The CPU(s) 1018 may include an X86 processor, for example. The CPU(s) 1018 may be used to perform any of a variety of functions, including arbitrating potentially inconsistent results between ADAS sensors and the SoC(s) 1004, and/or monitoring the status and health of the controller(s) 1036 and/or infotainment SoC 1030, for example.

The vehicle 1000 may include a GPU(s) 1020 (e.g., discrete GPU(s), or dGPU(s)), that may be coupled to the SoC(s) 1004 via a high-speed interconnect (e.g., NVIDIA's NVLINK). The GPU(s) 1020 may provide additional artificial intelligence functionality, such as by executing redundant and/or different neural networks, and may be used to train and/or update neural networks based on input (e.g., sensor data) from sensors of the vehicle 1000.

The vehicle 1000 may further include the network interface 1024 which may include one or more wireless antennas 1026 (e.g., one or more wireless antennas for different communication protocols, such as a cellular antenna, a Bluetooth antenna, etc.). The network interface 1024 may be used to enable wireless connectivity over the Internet with the cloud (e.g., with the server(s) 1078 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1000 information about vehicles in proximity to the vehicle 1000 (e.g., vehicles in front of, on the side of, and/or behind the vehicle 1000). This functionality may be part of a cooperative adaptive cruise control functionality of the vehicle 1000.

The network interface 1024 may include a SoC that provides modulation and demodulation functionality and enables the controller(s) 1036 to communicate over wireless networks. The network interface 1024 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1000 may further include data store(s) 1028 which may include off-chip (e.g., off the SoC(s) 1004) storage. The data store(s) 1028 may include one or more storage elements including RAM, SRAM, DRAM, VRAM, Flash, hard disks, and/or other components and/or devices that may store at least one bit of data.

The vehicle 1000 may further include GNSS sensor(s) 1058. The GNSS sensor(s) 1058 (e.g., GPS, assisted GPS sensors, differential GPS (DGPS) sensors, etc.), to assist in mapping, perception, occupancy grid generation, and/or path planning functions. Any number of GNSS sensor(s) 1058 may be used, including, for example and without limitation, a GPS using a USB connector with an Ethernet to Serial (RS-232) bridge.

The vehicle 1000 may further include RADAR sensor(s) 1060. The RADAR sensor(s) 1060 may be used by the vehicle 1000 for long-range vehicle detection, even in darkness and/or severe weather conditions. RADAR functional safety levels may be ASIL B. The RADAR sensor(s) 1060 may use the CAN and/or the bus 1002 (e.g., to transmit data generated by the RADAR sensor(s) 1060) for control and to access object tracking data, with access to Ethernet to access raw data in some examples. A wide variety of RADAR sensor types may be used. For example, and without limitation, the RADAR sensor(s) 1060 may be suitable for front, rear, and side RADAR use. In some example, Pulse Doppler RADAR sensor(s) are used.

The RADAR sensor(s) 1060 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1060 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1000 surroundings at higher speeds with minimal interference from traffic in adjacent lanes. The other two antennae may expand the field of view, making it possible to quickly detect vehicles entering or leaving the vehicle's 1000 lane.

Mid-range RADAR systems may include, as an example, a range of up to 1060 m (front) or 80 m (rear), and a field of view of up to 42 degrees (front) or 1050 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1000 may further include ultrasonic sensor(s) 1062. The ultrasonic sensor(s) 1062, which may be positioned at the front, back, and/or the sides of the vehicle 1000, may be used for park assist and/or to create and update an occupancy grid. A wide variety of ultrasonic sensor(s) 1062 may be used, and different ultrasonic sensor(s) 1062 may be used for different ranges of detection (e.g., 2.5 m, 4 m). The ultrasonic sensor(s) 1062 may operate at functional safety levels of ASIL B.

The vehicle 1000 may include LIDAR sensor(s) 1064. The LIDAR sensor(s) 1064 may be used for object and pedestrian detection, emergency braking, collision avoidance, and/or other functions. The LIDAR sensor(s) 1064 may be functional safety level ASIL B. In some examples, the vehicle 1000 may include multiple LIDAR sensors 1064 (e.g., two, four, six, etc.) that may use Ethernet (e.g., to provide data to a Gigabit Ethernet switch).

In some examples, the LIDAR sensor(s) 1064 may be capable of providing a list of objects and their distances for a 360-degree field of view. Commercially available LIDAR sensor(s) 1064 may have an advertised range of approximately 1000 m, with an accuracy of 2 cm-3 cm, and with support for a 1000 Mbps Ethernet connection, for example. In some examples, one or more non-protruding LIDAR sensors 1064 may be used. In such examples, the LIDAR sensor(s) 1064 may be implemented as a small device that may be embedded into the front, rear, sides, and/or corners of the vehicle 1000. The LIDAR sensor(s) 1064, in such examples, may provide up to a 120-degree horizontal and 35-degree vertical field-of-view, with a 200 m range even for low-reflectivity objects. Front-mounted LIDAR sensor(s) 1064 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1000. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1064 may be less susceptible to motion blur, vibration, and/or shock.

The vehicle may further include IMU sensor(s) 1066. The IMU sensor(s) 1066 may be located at a center of the rear axle of the vehicle 1000, in some examples. The IMU sensor(s) 1066 may include, for example and without limitation, an accelerometer(s), a magnetometer(s), a gyroscope(s), a magnetic compass(es), and/or other sensor types. In some examples, such as in six-axis applications, the IMU sensor(s) 1066 may include accelerometers and gyroscopes, while in nine-axis applications, the IMU sensor(s) 1066 may include accelerometers, gyroscopes, and magnetometers.

In some embodiments, the IMU sensor(s) 1066 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1066 may enable the vehicle 1000 to estimate heading without requiring input from a magnetic sensor by directly observing and correlating the changes in velocity from GPS to the IMU sensor(s) 1066. In some examples, the IMU sensor(s) 1066 and the GNSS sensor(s) 1058 may be combined in a single integrated unit.

The vehicle may include microphone(s) 1096 placed in and/or around the vehicle 1000. The microphone(s) 1096 may be used for emergency vehicle detection and identification, among other things.

The vehicle may further include any number of camera types, including stereo camera(s) 1068, wide-view camera(s) 1070, infrared camera(s) 1072, surround camera(s) 1074, long-range and/or mid-range camera(s) 1098, and/or other camera types. The cameras may be used to capture image data around an entire periphery of the vehicle 1000. The types of cameras used depends on the embodiments and requirements for the vehicle 1000, and any combination of camera types may be used to provide the necessary coverage around the vehicle 1000. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 10A and FIG. 10B.

The vehicle 1000 may further include vibration sensor(s) 1042. The vibration sensor(s) 1042 may measure vibrations of components of the vehicle, such as the axle(s). For example, changes in vibrations may indicate a change in road surfaces. In another example, when two or more vibration sensors 1042 are used, the differences between the vibrations may be used to determine friction or slippage of the road surface (e.g., when the difference in vibration is between a power-driven axle and a freely rotating axle).

The vehicle 1000 may include an ADAS system 1038. The ADAS system 1038 may include a SoC, in some examples. The ADAS system 1038 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1060, LIDAR sensor(s) 1064, and/or a camera(s). The ACC systems may include longitudinal ACC and/or lateral ACC. Longitudinal ACC monitors and controls the distance to the vehicle immediately ahead of the vehicle 1000 and automatically adjust the vehicle speed to maintain a safe distance from vehicles ahead. Lateral ACC performs distance keeping, and advises the vehicle 1000 to change lanes when necessary. Lateral ACC is related to other ADAS applications such as LCA and CWS.

CACC uses information from other vehicles that may be received via the network interface 1024 and/or the wireless antenna(s) 1026 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1000), while the I2V communication concept provides information about traffic further ahead. CACC systems may include either or both I2V and V2V information sources. Given the information of the vehicles ahead of the vehicle 1000, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1060, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1060, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1000 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1000 if the vehicle 1000 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1060, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1000 is backing up. Some RCTW systems include AEB to ensure that the vehicle brakes are applied to avoid a crash. RCTW systems may use one or more rear-facing RADAR sensor(s) 1060, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1000, the vehicle 1000 itself must, in the case of conflicting results, decide whether to heed the result from a primary computer or a secondary computer (e.g., a first controller 1036 or a second controller 1036). For example, in some embodiments, the ADAS system 1038 may be a backup and/or secondary computer for providing perception information to a backup computer rationality module. The backup computer rationality monitor may run a redundant diverse software on hardware components to detect faults in perception and dynamic driving tasks. Outputs from the ADAS system 1038 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1004.

In other examples, ADAS system 1038 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1038 may be fed into the primary computer's perception block and/or the primary computer's dynamic driving task block. For example, if the ADAS system 1038 indicates a forward crash warning due to an object immediately ahead, the perception block may use this information when identifying objects. In other examples, the secondary computer may have its own neural network which is trained and thus reduces the risk of false positives, as described herein.

The vehicle 1000 may further include the infotainment SoC 1030 (e.g., an in-vehicle infotainment system (IVI)). Although illustrated and described as a SoC, the infotainment system may not be a SoC, and may include two or more discrete components. The infotainment SoC 1030 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1000. For example, the infotainment SoC 1030 may radios, disk players, navigation systems, video players, USB and Bluetooth connectivity, carputers, in-car entertainment, Wi-Fi, steering wheel audio controls, hands free voice control, a heads-up display (HUD), an HMI display 1034, a telematics device, a control panel (e.g., for controlling and/or interacting with various components, features, and/or systems), and/or other components. The infotainment SoC 1030 may further be used to provide information (e.g., visual and/or audible) to a user(s) of the vehicle, such as information from the ADAS system 1038, autonomous driving information such as planned vehicle maneuvers, trajectories, surrounding environment information (e.g., intersection information, vehicle information, road information, etc.), and/or other information.

The infotainment SoC 1030 may include GPU functionality. The infotainment SoC 1030 may communicate over the bus 1002 (e.g., CAN bus, Ethernet, etc.) with other devices, systems, and/or components of the vehicle 1000. In some examples, the infotainment SoC 1030 may be coupled to a supervisory MCU such that the GPU of the infotainment system may perform some self-driving functions in the event that the primary controller(s) 1036 (e.g., the primary and/or backup computers of the vehicle 1000) fail. In such an example, the infotainment SoC 1030 may put the vehicle 1000 into a chauffeur to safe stop mode, as described herein.

The vehicle 1000 may further include an instrument cluster 1032 (e.g., a digital dash, an electronic instrument cluster, a digital instrument panel, etc.). The instrument cluster 1032 may include a controller and/or supercomputer (e.g., a discrete controller or supercomputer). The instrument cluster 1032 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1030 and the instrument cluster 1032. In other words, the instrument cluster 1032 may be included as part of the infotainment SoC 1030, or vice versa.

FIG. 10D is a system diagram for communication between cloud-based server(s) and the example autonomous vehicle 1000 of FIG. 10A, in accordance with some embodiments of the present disclosure. The system 1076 may include server(s) 1078, network(s) 1090, and vehicles, including the vehicle 1000. The server(s) 1078 may include a plurality of GPUs 1084(A)-1084(H) (collectively referred to herein as GPUs 1084), PCIe switches 1082(A)-1082(H) (collectively referred to herein as PCIe switches 1082), and/or CPUs 1080(A)-1080(B) (collectively referred to herein as CPUs 1080). The GPUs 1084, the CPUs 1080, and the PCIe switches may be interconnected with high-speed interconnects such as, for example and without limitation, NVLink interfaces 1088 developed by NVIDIA and/or PCIe connections 1086. In some examples, the GPUs 1084 are connected via NVLink and/or NVSwitch SoC and the GPUs 1084 and the PCIe switches 1082 are connected via PCIe interconnects. Although eight GPUs 1084, two CPUs 1080, and two PCIe switches are illustrated, this is not intended to be limiting. Depending on the embodiment, each of the server(s) 1078 may include any number of GPUs 1084, CPUs 1080, and/or PCIe switches. For example, the server(s) 1078 may each include eight, sixteen, thirty-two, and/or more GPUs 1084.

The server(s) 1078 may receive, over the network(s) 1090 and from the vehicles, image data representative of images showing unexpected or changed road conditions, such as recently commenced road-work. The server(s) 1078 may transmit, over the network(s) 1090 and to the vehicles, neural networks 1092, updated neural networks 1092, and/or map information 1094, including information regarding traffic and road conditions. The updates to the map information 1094 may include updates for the HD map 1022, such as information regarding construction sites, potholes, detours, flooding, and/or other obstructions. In some examples, the neural networks 1092, the updated neural networks 1092, and/or the map information 1094 may have resulted from new training and/or experiences represented in data received from any number of vehicles in the environment, and/or based on training performed at a datacenter (e.g., using the server(s) 1078 and/or other servers).

The server(s) 1078 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1090, and/or the machine learning models may be used by the server(s) 1078 to remotely monitor the vehicles.

In some examples, the server(s) 1078 may receive data from the vehicles and apply the data to up-to-date real-time neural networks for real-time intelligent inferencing. The server(s) 1078 may include deep-learning supercomputers and/or dedicated AI computers powered by GPU(s) 1084, such as a DGX and DGX Station machines developed by NVIDIA. However, in some examples, the server(s) 1078 may include deep learning infrastructure that use only CPU-powered datacenters.

The deep-learning infrastructure of the server(s) 1078 may be capable of fast, real-time inferencing, and may use that capability to evaluate and verify the health of the processors, software, and/or associated hardware in the vehicle 1000. For example, the deep-learning infrastructure may receive periodic updates from the vehicle 1000, such as a sequence of images and/or objects that the vehicle 1000 has located in that sequence of images (e.g., via computer vision and/or other machine learning object classification techniques). The deep-learning infrastructure may run its own neural network to identify the objects and compare them with the objects identified by the vehicle 1000 and, if the results do not match and the infrastructure concludes that the AI in the vehicle 1000 is malfunctioning, the server(s) 1078 may transmit a signal to the vehicle 1000 instructing a fail-safe computer of the vehicle 1000 to assume control, notify the passengers, and complete a safe parking maneuver.

For inferencing, the server(s) 1078 may include the GPU(s) 1084 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). In other words, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that enable the computing device 1100 to communicate with other computing devices via an electronic communication network, included wired and/or wireless communications. The communication interface 1110 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may enable the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that enable detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to enable the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161(N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1233, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™ (hereinafter “Spark”) that may utilize distributed file system 1238 for large-scale data processing (e.g., “big data”). In at least one embodiment, job scheduler 1233 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1233. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A. A method comprising: determining, using map data corresponding to a navigational map or a standard definition (SD) map, a path of a machine with respect to at least a portion road network; generating, based at least on sensor data obtained using one or more sensors of the machine, perception data indicative of at least a plurality of lane line markings corresponding to a plurality of lanes associated with the path through at least the portion of the road network; determining, based at least on one or more line types associated with the plurality of lane line markings, a plurality of behaviors of the plurality of lanes with respect to at least the portion of the road network; determining at least a first lane of the plurality of lanes having at least a first behavior of the plurality of behaviors that corresponds to the path of the machine with respect to the at least the portion of the road network; and causing the machine to perform one or more operations associated with using at least the first lane for the path.

B. The method as recited in paragraph A, wherein the one or more operations include causing one or more lane changes of the machine from one or more second lanes of the plurality of lanes to the first lane.

C. The method as recited in any one of paragraphs A-B, further comprising: determining, based at least on a location of the machine, one or more traffic rules corresponding to the one or more line types associated with the plurality of lane line markings, wherein the determining of the plurality of behaviors of the plurality of lanes is further based at least on the one or more traffic rules.

D. The method as recited in any one of paragraphs A-C, wherein the determining of the plurality of behaviors of the plurality of lanes comprises: applying at least the perception data as input data to one or more machine learning models; and obtaining, as output data from the one or more machine learning models, at least one of: data indicating the plurality of behaviors of the plurality of lanes; or classification data indicating the one or more line types associated with the plurality of lane line markings.

E. The method as recited in any one of paragraphs A-D, wherein the determining of the plurality of behaviors of the plurality of lanes is further based at least on image data representing one or more images depicting one or more road signs, the road signs indicating at least one or more traffic rules for the plurality of lanes that are indicative of the plurality of behaviors of the plurality of lanes.

F. The method as recited in any one of paragraphs A-E, further comprising: determining, based at least on the perception data, one or more patterns associated with the plurality of lane line markings, wherein the determining of the plurality of behaviors of the plurality of lanes is further based at least on the one or more patterns.

G. The method as recited in any one of paragraphs A-F, further comprising: determining, based at least on the map data, a road topology associated with the at least the portion of the road network; and determining one or more relationships between the road topology and one or more geometries associated with the plurality of lanes, wherein the determining of the plurality of behaviors of the plurality of lanes is further based at least on the one or more relationships.

H. A system comprising: one or more processors to: classify one or more surface markings corresponding to one or more edges of one or more lanes along a path determined using map data; determine, based at least on the classification of the one or more surface markings, one or more behaviors associated with the one or more lanes; select, based at least on the one or more behaviors, at least a first lane of the one or more lanes for a machine to use to navigate the path; and cause the machine to perform one or more operations associated with using the first path to navigate the path.

I. The system as recited in paragraph H, the one or more processors further to determine a location of the machine with respect to the one or more lanes based at least on the one or more behaviors associated with the one or more lanes.

J. The system as recited in any one of paragraphs H-I, the one or more processors further to: determine, based at least on sensor data obtained using one or more sensors of the machine, a geographic region the machine is operating in, wherein the classification of the one or more surface markings is further based at least on the geographic region.

K. The system as recited in any one of paragraphs H-J, the one or more processors further to: obtain data indicating the path the machine is to navigate; and determine that a behavior associated with the first lane corresponds to an action to be performed by the machine to navigate the path, wherein the selection of the at least the first lane is based at least on the behavior corresponding to the action.

L. The system as recited in any one of paragraphs H-K, the one or more processors further to: apply, to one or more machine learning models, sensor data obtained using one or more sensors of a machine; and determine, using the one or more machine learning models, one or more traffic rules associated with the one or more surface markings, wherein the determination of the one or more behaviors associated with the one or more lanes is based at least on the one or more traffic rules.

M. The system as recited in any one of paragraphs H-L, the one or more processors further to: determine, based at least on one or more traffic signs, one or more second behaviors associated with one or more second lanes, wherein the selection of the at least the first lane is further based at least on the one or more second behaviors.

N. The system as recited in any one of paragraphs H-M, the one or more processors further to: determine one or more patterns associated with one or more classifications of the one or more surface markings, wherein the determination of the one or more behaviors is based at least on the one or more patterns.

O. The system as recited in any one of paragraphs H-N, wherein the one or more surface markings correspond to one or more lane line markings associated with the one or more lanes.

P. The system as recited in any one of paragraphs H-O, wherein the one or more operations include at least causing the machine to change from using a second lane of the one or more lanes to using the first lane for navigating the path based at least on the one or more behaviors associated with the one or more lanes.

Q. The system as recited in any one of paragraphs H-P, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using a large language model; a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

R. A machine comprising: a powertrain; one or more central processing units (CPUs); one or more graphics processing units (GPUs); one or more hardware accelerators; one or more internal sensors for monitoring one or more passengers in-cabin; and one or more external sensors for perceiving an environment outside of the machine, wherein the machine is to perform one or more control operations within one or more lanes of the environment based at least on map data indicating a path through the environment and sensor data obtained using the more external sensors, wherein the sensor data is processed to determine, based at least on behavior information associated with one or more lanes in the environment, a lane of the one or more lanes for the machine to occupy in order to navigate in accordance with the path.

S. The machine as recited in paragraph R, further comprising a human-machine interface (HMI), and the path is selected based at least on one or more user inputs to the HMI.

T. The one or more processors as recited in any one of paragraphs R-S, wherein the map data corresponds to a navigation map or a standard definition (SD) map, and does not include lane information corresponding to the one or more lanes.

What is claimed is:

1. A method comprising:
determining, using map data corresponding to a navigational map or a standard definition (SD) map, a path of a machine with respect to at least a portion road network;
generating, based at least on sensor data obtained using one or more sensors of the machine, perception data indicative of at least a plurality of lane line markings corresponding to a plurality of lanes associated with the path through at least the portion of the road network;
determining, based at least on one or more line types associated with the plurality of lane line markings, a plurality of behaviors of the plurality of lanes with respect to at least the portion of the road network;
determining at least a first lane of the plurality of lanes having at least a first behavior of the plurality of behaviors that corresponds to the path of the machine with respect to the at least the portion of the road network; and
causing the machine to perform one or more operations associated with using at least the first lane for the path.

2. The method of claim 1, wherein the one or more operations include causing one or more lane changes of the machine from one or more second lanes of the plurality of lanes to the first lane.

3. The method of claim 1, further comprising:
determining, based at least on a location of the machine, one or more traffic rules corresponding to the one or more line types associated with the plurality of lane line markings,
wherein the determining of the plurality of behaviors of the plurality of lanes is further based at least on the one or more traffic rules.

4. The method of claim 1, wherein the determining of the plurality of behaviors of the plurality of lanes comprises:
applying at least the perception data as input data to one or more machine learning models; and
obtaining, as output data from the one or more machine learning models, at least one of:
data indicating the plurality of behaviors of the plurality of lanes; or
classification data indicating the one or more line types associated with the plurality of lane line markings.

5. The method of claim 1, wherein the determining of the plurality of behaviors of the plurality of lanes is further based at least on image data representing one or more images depicting one or more road signs, the road signs indicating at least one or more traffic rules for the plurality of lanes that are indicative of the plurality of behaviors of the plurality of lanes.

6. The method of claim 1, further comprising:
determining, based at least on the perception data, one or more patterns associated with the plurality of lane line markings,
wherein the determining of the plurality of behaviors of the plurality of lanes is further based at least on the one or more patterns.

7. The method of claim 1, further comprising:
determining, based at least on the map data, a road topology associated with the at least the portion of the road network; and
determining one or more relationships between the road topology and one or more geometries associated with the plurality of lanes,
wherein the determining of the plurality of behaviors of the plurality of lanes is further based at least on the one or more relationships.

8. A system comprising:
one or more processors to:
classify one or more surface markings corresponding to one or more edges of one or more lanes along a path determined using map data;
determine, based at least on the classification of the one or more surface markings, one or more behaviors associated with the one or more lanes;
select, based at least on the one or more behaviors, at least a first lane of the one or more lanes for a machine to use to navigate the path; and
cause the machine to perform one or more operations associated with using the first path to navigate the path.

9. The system of claim 8, the one or more processors further to determine a location of the machine with respect to the one or more lanes based at least on the one or more behaviors associated with the one or more lanes.

10. The system of claim 8, the one or more processors further to:
determine, based at least on sensor data obtained using one or more sensors of the machine, a geographic region the machine is operating in,
wherein the classification of the one or more surface markings is further based at least on the geographic region.

11. The system of claim 8, the one or more processors further to:
obtain data indicating the path the machine is to navigate; and
determine that a behavior associated with the first lane corresponds to an action to be performed by the machine to navigate the path,
wherein the selection of the at least the first lane is based at least on the behavior corresponding to the action.

12. The system of claim 8, the one or more processors further to:
apply, to one or more machine learning models, sensor data obtained using one or more sensors of a machine; and
determine, using the one or more machine learning models, one or more traffic rules associated with the one or more surface markings,
wherein the determination of the one or more behaviors associated with the one or more lanes is based at least on the one or more traffic rules.

13. The system of claim 8, the one or more processors further to:
determine, based at least on one or more traffic signs, one or more second behaviors associated with one or more second lanes,
wherein the selection of the at least the first lane is further based at least on the one or more second behaviors.

14. The system of claim 8, the one or more processors further to:
determine one or more patterns associated with one or more classifications of the one or more surface markings,
wherein the determination of the one or more behaviors is based at least on the one or more patterns.

15. The system of claim 8, wherein the one or more surface markings correspond to one or more lane line markings associated with the one or more lanes.

16. The system of claim 8, wherein the one or more operations include at least causing the machine to change from using a second lane of the one or more lanes to using the first lane for navigating the path based at least on the one or more behaviors associated with the one or more lanes.

17. The system of claim 8, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model;
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

18. A machine comprising:
a powertrain;
one or more central processing units (CPUs);
one or more graphics processing units (GPUs);
one or more hardware accelerators;
one or more internal sensors for monitoring one or more passengers in-cabin; and
one or more external sensors for perceiving an environment outside of the machine,
wherein the machine is to perform one or more control operations within one or more lanes of the environment based at least on map data indicating a path through the environment and sensor data obtained using the one or more external sensors, wherein the sensor data is processed to determine, based at least on behavior information associated with one or more lanes in the environment, a lane of the one or more lanes for the machine to occupy in order to navigate in accordance with the path.

19. The machine of claim 18, further comprising a human-machine interface (HMI), and the path is selected based at least on one or more user inputs to the HMI.

20. The one or more processors of claim 18, wherein the map data corresponds to a navigation map or a standard definition (SD) map, and does not include lane information corresponding to the one or more lanes.
